(19) United States
(12) Patent Application Publication
(10) Pub. No.: US 2002/0059299 A1
(43) Pub. Date: May 16, 2002

(54) System and method for synchronizing databases

(76) Inventor: Frederic Spaey, Brussels (BE)

Correspondence Address: Tyler S. Brown, Morrison & Foerster LLP, 2000 Pennsylvania Ave., N.W., Washington, DC, 20006-1888, US

(21) Appl. No.: 09/766,637

(22) Filed: Jan. 23, 2001

Related U.S. Application Data
(60) Provisional application No. 60/218,925, filed on Jul. 14, 2000.

(51) Int. Cl. G06F 7/00

(52) U.S. Cl. 707/104.1

(57) ABSTRACT

A data processing method and system including a plurality of databases linked by at least one communication channels, a synchronization set which defines the objects or records to be synchronized between the plurality of databases, and a synchronizer for each database which controls and monitors the synchronization between databases and accesses a local database to which the synchronizer is connected. Each synchronizer includes a communications module which monitors and controls the communication with other databases and at least one table synchronizer which controls and monitors the synchronization of the local database and access to the local database. Each table synchronizer includes a table synchronizer engine which handle the synchronization management for its table synchronizer, a plug-in which handle the generic database communication for its table synchronizer, and a driver which controls communication with the local database. The data processing method synchronizes data records of a source database and a destination database. The method includes defining a synchronization set for data records existing in the source database, synchronizing the source database and the destination database based on the synchronization set, and changing the definition of the synchronization set while synchronizing the source database and the destination database.

### FIELD OF THE INVENTION

The present invention relates generally to a system and method of updating data on several databases. More particularly, the present invention relates to a system and method of dynamically updating synchronized databases connected by a communication channel.

### BACKGROUND OF THE INVENTION

Databases are one of the most widely used tools in computing today. A database is a collection of related information about a subject. It is organized in a useful manner that provides a base for procedures such as retrieving information, drawing conclusions and making decisions.

A database is a collection of objects (called records). Each object is made of one or more characteristics (called fields). Similar objects are often grouped in a list (called table).

A shared database is a database that can be accessed from many different users residing in different locations. Those locations are connected through a communication network to the shared database.

Considering one user accessing to a shared database, the shared database is made of two databases in reality (see FIG. 1). The first one is the remote database the user want to access; the second one is contains the local data directly useable by the user's application. This local database often resides in memory and often contains only a subset of the information contained in the remote database. Conventionally, different models are used to manage those two databases.

Direct access model: This model only uses the local database as working memory space. It relies heavily on the communication network to feed this local memory with the information the user application needs. It fetches all the tables and index data to satisfy the local user's application queries. The direct access model requires all the working data (indexes and records) and the result data (records) to be transferred for each query. This is very burdensome on the communication channel.

Client/server model: This model transfers from the server (remote database) to the client (local database) the data corresponding to the results of the queries, so the user's application can work with that data. It relies on the server to execute the queries. There is no local optimization of the queries. Each query requires a roundtrip from the client to the server and back to the client.

Replication model: This model copies the whole database locally. This is a problem because the local database has to keep a copy of all the data in the remote database whether it is necessary to the synchronization or not. This model requires the local computer to handle the full sized remote database. This model only works when both databases have the same format.

Synchronization model: This model is an extension of the replication model where the remote and local databases can be of different formats. Most recent synchronization models allow that only a part of the remote database is transferred locally (synchronization based on query). However, current synchronization models cannot be updated dynamically.

The direct access and client/server models require fast and powerful communication network between the client and the server. They need a permanent connection between the remote and the local database. This requires a high availability of the servers because no down time is accepted by the users. The number of concurrent users is limited by the performances of the servers.

The replication model requires heavy administration to keep the databases identical. Any error in communication or transaction can break this strict synchronization.

In the replication and synchronization models, the synchronization definition (the way records are synchronized) can't be changed, added or removed while the synchronization process is running. Furthermore, if the synchronization definition is changed, the local synchronized records are not removed accordingly. When a remote record is changed in such a way that its synchronized status is changed from ‘synchronized’ to ‘non-synchronized’, it is not removed from the local database. The replication and synchronization models require the remote database to keep track of all the changes applied to the synchronized records (transaction or update log). This causes heavy processing and slows down operations for applications on the remote side.

The replication and synchronization models are too static to be used efficiently inside an application working memory, like the direct access and client/server models are able to do.

All four models are concerned only with a one-to-one relationship. There can only be one, well defined remote database connected to one, well-defined local database. Both side of the connection are dedicated. Communication is done using a specifically designed language.

Furthermore, the user's application cannot access multiple remote databases and handle the data as a unique set of records. Each remote database must have one corresponding local database. No data merging is possible.

All four models use record level granularity. The smallest data unit that is transferred is one record (one object).

Theses and other drawbacks and deficiencies exist in existing systems and methods.

### SUMMARY OF THE INVENTION

The present invention provides a new way to transfer data. It allows generic and optimized communication between differently formatted databases, proposing an alternative to direct access, client/server, replication and classical synchronization models.

According to one embodiment of the invention, a data processing method and system is provided which includes: a plurality of databases linked by at least one communication channel, a synchronization set which defines the objects or records to be synchronized between the plurality of databases, and a synchronizer for each database which controls and monitors the synchronization between databases and accesses a local database to which the synchronizer is connected. Each synchronizer includes a communications module which monitors and controls the communication with other databases and at least one table synchronizer which controls and monitors the synchronization of the local database and access to the local database and a synchronizer database (SDB) which stores internal synchronization data such as the last update time of a synchronized record. Each table synchronizer includes a table synchronizer engine which handle the synchronization management for its table synchronizer, a plug-in which handles the generic database communication for its table synchronizer, and a driver which controls communication with the local database.

The table synchronizers allow any kind of databases to be linked. The database can reside on disk or in memory, they can be of any format, from old ‘flat’ database to recent object oriented database formats (as long as the database contains a collection of structured objects). The databases do not need to hold specific information about synchronization. The user's application can continue to access the database locally while the communication process with the other databases takes place.

The synchronizer and the SDB allow the present invention to transfer only needed data from the database and reuse existing data in the SDB to handle queries. This provides an advantage over the direct access model.

The table synchronizer and the SDB interact to combine overlapping queries with similar requests. By combining queries before accessing the database, the present invention decreases the access time of the database resulting in local optimization. This provides an advantage over the client server model.

The synchronizer and SDB interact to retrieve only the needed data from the database and store data in the SDB. The retrieval and storage of only needed or requested data avoid duplication of the database locally. This provides an advantage over the replication model.

The synchronizer and SDB interact to remove, add, and modify synchronization definition while still allowing local access to the synchronized data resulting in dynamic synchronization. Specifically, if the synchronization definition is changed, all the components of the synchronizer that use the information are notified immediately and react accordingly, even if they are in the middle of doing something else. This provides an advantage over the conventional synchronization models that deny access to synchronized data while the synchronization definition is being modified, added or removed.

The synchronizer also allows local synchronized records to be removed when the synchronization definition is changed. The synchronizer includes various subcomponents (Qes, Qr, Pr, Pe, Prd, and Ped) that process the synchronization definition change notification. For example, if a synchronization definition is changed, Qes, a synchronizer subcomponent, is notified. Qes then starts a new refresh cycle which removes any local records that are no longer part of a synchronization definition. This provides an advantage over conventional systems.

In one aspect, the data processing method synchronizes data records of a source database and a destination database. The method includes defining a synchronization set for data records existing in the source database, synchronizing the source database and the destination database based on the synchronization set, and changing the definition of the synchronization set while synchronizing the source database and the destination database.

In another aspect, records to transfer are selected by the synchronization process. This selection allows partial and optimized communication between the databases. The data is transferred with a field level granularity, but databases coherence is respected (all modified fields for a given object can be transferred together).

The connection between databases can be discontinuous; the databases are updated when the connection is re-established.

Because of the dynamic nature of the synchronizer, a synchronization definition can be added, changed or removed ‘live’. Synchronized records are added, updated or removed accordingly. The definition can be used to query remote databases, access locally the resulting records and remove those local records when the query result is not needed anymore.

Multiple synchronization definitions can provide fields from multiple remote databases for merging in one record in a local database. The local database contains the net result of the merged information from multiple remote databases. Merging occurs on different levels: records may be merged in a table (table level) or fields in records (record level).

In another aspect, the present invention provides a system and method for synchronizing data records of a plurality of databases. The system and method defines at least one synchronization set of data records that exist in one of the plurality of databases (source database); synchronizes the source database and one of the plurality of databases (destination database) based on the synchronization set; and allows changes to the definition of the synchronization set while the synchronization is active or live. The method can remove a data record from the destination database based on the step of changing the definition of the synchronization set. The method can also delete a data record belonging to the synchronization set from the source database and remove the data record from the destination database based on the deleting of the data record in the source database.

In another aspect, the present embodiment provides a system and method for synchronizing data records of a plurality of databases. The system and method defines a synchronization set for data records existing in at least one of the plurality of databases; synchronizes the plurality of databases based on the synchronization set; and changes the definition of the synchronization set while synchronizing the plurality of databases. The system and method can remove a data record from at least one of the plurality of databases based on the step of changing the definition of the synchronization set. Also, the process of synchronizing the plurality of databases can include merging data from at least two of the plurality of databases into a data record in one of the plurality of databases.

In another aspect, the present embodiment provides a system and method synchronizing data records of a source database and a destination database. The system and method defines a synchronization set for data records existing in the source database; synchronizes the source database and the destination database based on the synchronization set; and scans the data records in the source database defined in the synchronization set. The system and method can receive a plurality of queries for information on data records defined in the synchronization set and scanning can include combining the plurality of received queries before scanning the source database.

In another aspect, the present embodiment of the invention provides a system and method for synchronizing data records of a source database and a destination database. The system and method defines a synchronization set for data records existing in the source database; synchronizes the source database and the destination database based on the synchronization set; and creates a notification packet for each data record defined in the synchronization set and modified in the source database, the notification packet containing only an indication of modification. The system and method can define a synchronization set for data records existing in the source database; synchronize the source database and the destination database based on the synchronization set; and create a user flag each data record defined in the synchronization set and modified in the destination database. Also, the system and method can define a synchronization set for data records existing in the source database; hash information on the data records defined by the synchronization set; send the hashing information to the destination database; and synchronize the source database and the destination database based on the synchronization set. The system and method also can receive a request for hashing information on at least on data record defined by the synchronization set at the source database from the destination database and send the at least one data record to the destination database.

According to one embodiment of the invention, a computer system is provided which includes: a processor, a memory coupled to said processor; the memory having stored therein sequences of instructions which, when executed by said processor, cause said processor to synchronize data records of the source database and the destination database by causing the processor to perform the steps of (a) defining a synchronization set for data records existing in the source database; (b) synchronizing the source database and the destination database based on the synchronization set; and (c) changing the definition of the synchronization set while synchronizing the source database and the destination database.

According to one embodiment of the invention, an article of manufacture is provided which includes a medium readable by a processor, the medium having stored thereon a plurality of sequences of instructions, said plurality of sequences of instructions including sequences of instructions which, when executed by a processor, cause said processor to perform the steps of: (a) defining a synchronization set for data records existing in a source database; (b) synchronizing the source database and a destination database based on the synchronization set; and (c) changing the definition of the synchronization set while synchronizing the source database and the destination database.

The above and other embodiments, aspects, features, and advantages of the present invention will become readily apparent from the following detailed description that is to be read in conjunction with the accompanying drawings.

### DESCRIPTION OF THE DRAWINGS

FIG. 1 illustrates an example of shared databases.

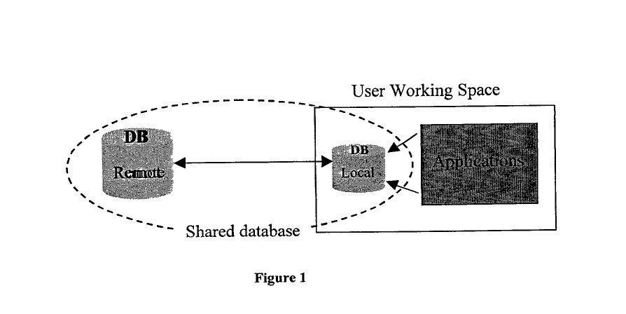

FIG. 2 illustrates the basic synchronization components according to one embodiment of the invention.

FIG. 3 illustrates atomic synchronization between two databases according to one embodiment of the invention.

FIG. 4 illustrates a network of atomic synchronization according to one embodiment of the invention.

FIG. 5 illustrates storage of specific synchronization data according to one embodiment of the invention.

FIG. 6 illustrates synchronizers in a network of synchronizations according to one embodiment of the invention.

FIG. 7 illustrates a loop of atomic synchronizations according to one embodiment of the invention.

FIG. 8A illustrates a synchronizer overview according to one embodiment of the invention.

FIG. 8B illustrates the content of the SDB according to one embodiment of the invention.

FIG. 9 illustrates an initial phase between 2 synchronizers according to one embodiment of the invention.

FIG. 10 illustrates SDB A and B before the start of the initialization phase according to one embodiment of the invention.

FIG. 11 illustrates SDB A and B after initialization 1 packet according to one embodiment of the invention.

FIG. 12 illustrates SDB A and B after initialization 2 according to one embodiment of the invention.

FIG. 13 illustrates SDB A and B after reception of two initialization packets 1 crossing each other according to one embodiment of the invention.

FIG. 14 illustrates SDB A and B after reception of two initialization packets 2 crossing each other according to one embodiment of the invention.

FIG. 15 illustrates table synchronizer subcomponents according to one embodiment of the invention.

FIG. 16A illustrates a Qes loop process according to one embodiment of the invention.

FIG. 16B illustrates a Qes loop process according to one embodiment of the invention.

FIG. 17 illustrates a filter process flowchart according to one embodiment of the invention.

FIG. 18A illustrates a Prd process according to one embodiment of the invention.

FIG. 18B illustrates a Prd process according to one embodiment of the invention.

FIG. 19 illustrates a Ped process according to one embodiment of the invention.

FIG. 20 illustrates a Qr process according to one embodiment of the invention.

FIG. 21 illustrates a Qe process according to one embodiment of the invention.

FIG. 22 illustrates a Pr process according to one embodiment of the invention.

FIG. 23 illustrates a Pe process according to one embodiment of the invention.

FIG. 24A illustrates field matching between database A and B for the creation of one record in a source database example according to one embodiment of the invention.

FIG. 24B illustrates a creation of record in a source database example according to one embodiment of the invention.

FIG. 25 illustrates a synchronization process for a record creation example according to one embodiment of the invention.

FIG. 26A illustrates field matching between database A and B for a field modification and channel disconnection example according to one embodiment of the invention.

FIG. 26B illustrates a field modification example according to one embodiment of the invention.

FIG. 27 illustrates a synchronization process for a field modification example according to one embodiment of the invention.

FIG. 28 illustrates a change of synchronization query example according to one embodiment of the invention.

FIG. 29A illustrates field matching between database A and B for a change of query, suppression in destination source, and user flag example according to one embodiment of the invention.

FIG. 29B illustrates field matching between database A and B for a merging example according to one embodiment of the invention.

FIG. 29C illustrates field matching between database C and B for a merging example according to one embodiment of the invention.

FIG. 29D illustrates a field merging example according to one embodiment of the invention.

### DETAILED DESCRIPTION OF PREFERRED EMBODIMENTS OF THE INVENTION

The following description is presented to enable any person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art would realize that the invention may be practiced without the use of these specific details. In other instances, well-known structures and devices are shown in block diagram form in order not to obscure the description of the invention with unnecessary detail. Thus, the present invention is not intended to be limited to the embodiment shown, but is to be accorded the widest scope consistent with the principles and features disclosed herein.

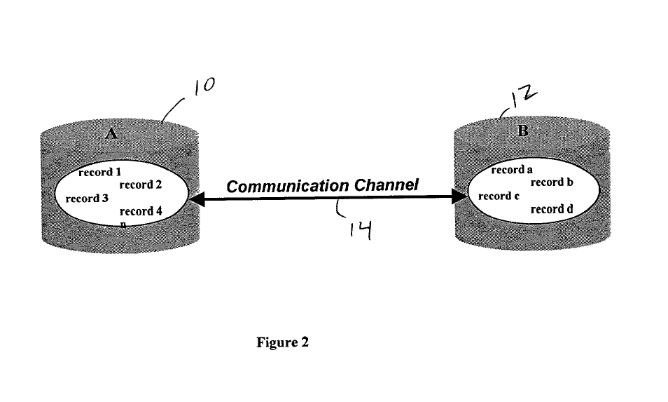

The present invention encompasses a system and method of synchronization. Synchronization is defined as an updating process for a set of objects or records residing in different databases 10 and 12 (see FIG. 2). The characteristics of the objects are the fields. The databases 10 and 12 communicate via a communication channel 14. Communication channel 14 can be any type of communication channel that allows communication of data over the channel, such as wireless transmission channel or fiber optic network.

Hereinafter synchronization is defined as a combination of atomic synchronizations. The atomic synchronization is the basic building block of the synchronization model of a present embodiment of the invention.

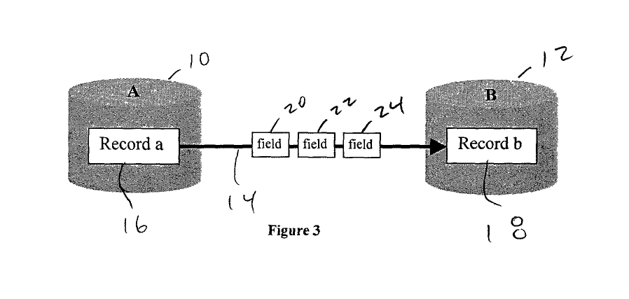

Atomic synchronization is the simplest case of synchronization. It operates on two sets of records 16 and 18 residing in two databases 10 and 12 linked by one communication channel 14 (see FIG. 3).

An atomic synchronization is unidirectional as it defines a source database 10(A) and a destination database 12(B). Fields 20, 22, and 24 are transferred through the communication channel 14: A change of a field value in the source database 10 causes a change of the field value in the destination database 12, but the opposite is not true.

Changed fields are transferred in ‘packets’ representing logical records in both databases 10 and 12 (objects). A logical record is a collection of related fields. It can correspond to one or more physical records.

The atomic synchronization is further defined by an access to source database 10 (A) and an access to destination database 12(B). The synchronization and local user's applications can access the databases simultaneously. User's access to the databases 10 and 12 is generally never blocked nor restricted due to synchronization.

The communication channel 14 is established between databases 10 and 12 on separate computers or on the same computer and carries field value and synchronization information.

The communication channel 14 can carry both values of fields and synchronization information. Modification time (timestamp) of a field value is a typical example of synchronization information.

Several synchronizations between databases 10 and 12 can share the same communication channel 14 and database access. Typically, the communication channel 14 is implemented over TCP/IP.

The synchronization minimizes as much as possible the information exchanged over the communication channel 14: only the required modification information is sent and the data is compressed. Thus, the problem associated with the replication model, i.e. copy the whole database, can be avoided.

The communication channel 14 can be discontinuous; the synchronization is responsible for updating values in destination database 12(B) after the (re) establishing of the communication channel 14.

Detection

The synchronization must detect in a database any change of value of a field participating in a synchronization. A change may be either a modification of the value, a creation of a field or a suppression of a field.

Basically, three detection methods are used:

Notification: In this case, the database notifies any change of any field in the database. The notification is directly handled by the synchronization. The notification is not implemented in all database systems.

Modification query: If the database is equipped with a modification tag at the record or field level, the modifications are queried and the modified record are directly handled by the synchronization.

Scanning: If notification and modification query are not available, the only way to detect a change in the database is to scan the database for all the records and fields conforming to the definition of the synchronization query.

The synchronization chooses the best detection method in real-time. If the database supports notifications and communication with the database is continuous, notification is used. In case of disconnection with the database, scanning or modification query are used at least once to restore data integrity, then the synchronization automatically switches to notification.

A source record key and a source synchronization field mask can be used to identify the record 16 in the source database 10(A) containing the fields to be synchronized. The set of synchronized fields in the source database 10 is the source synchronization field mask. Use of the synchronization field mask allows the synchronization method to achieve field level granularity because individual fields can be selected as opposed to entire records.

The selection of fields in the source database 10 can be divided in two steps. First, a synchronization query selects records and then a synchronization field mask is applied in each resulting record to obtain the source fields to synchronize.

The system and method can also include a destination record key and a destination synchronization field mask. The destination record key can be used to identify the record 18 in the destination database 12(B) that will receive the synchronized fields. The set of synchronized fields in the destination database 12 is the destination synchronization field mask.

The following is an example of field matching between database 10(A) and database 12(B). There is a one-to-one matching between fields in database 10 and fields in database 12. A one-to-many relationship and computed fields is also possible.

Suppose that data sent by database 10 arrives at database 12. In database 12, the corresponding record is selected according to the record key. Then, fields can be inserted, modified or removed according to the following rule:

If the selected fields are missing in database 12, they are inserted.

If the fields are still present in database 12 but not in database 10, they are removed.

If the value in database 12 is older, the field is updated.

The fact that the field is added or removed in database 12 is not only dependent on the fact that those fields have been added or removed in database 10, it also depends on the fact that the field is synchronized or not. Any change in the source record key or in the synchronization definition itself can influence the presence of the field in the database 12.

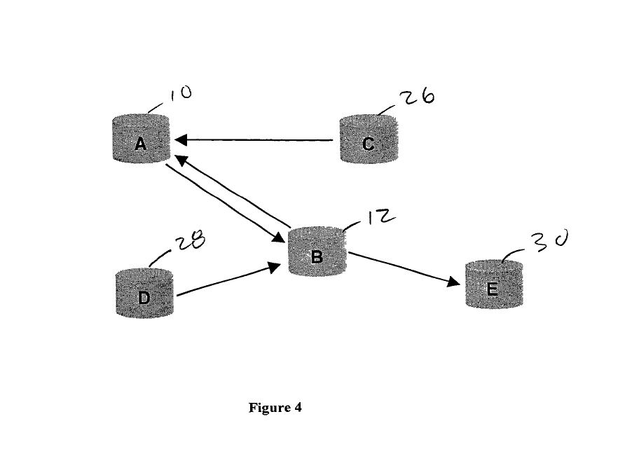

Atomic synchronizations can be combined to provide a network of synchronizations between any numbers of databases (see FIG. 4).

Database 10 ⇄database 12: Bi-directional network of synchronizations is achieved by linking 2 databases with 2 synchronizations. The atomic synchronization definition from database 10 to database 12 can differ from the atomic synchronization definition from database 12 to database 10.

For example, suppose that the atomic synchronization from database 10 to database 12 is defined on field 1 and 2 while the synchronization from database 12 to database 10 is defined only on field 1. In this case a change of field 1 in database 10 will cause the update of field 1 in database 12 and conversely. In opposition, a change on field 2 in database 10 will force the updated in database 12 but a change on field 2 in database 12 will not force the update in database 10.

Database 10, database 28→database 12: Multiple atomic synchronizations can feed one database. The data is merged in the destination database. Records from different source databases will appear together in the same destination database. Furthermore, since the destination record is selected on a key basis, fields from different databases can be merged into the same record. Therefore there are 2 level of data merging: at the table level, where records are merged in a common table, or at the record level, where fields are merged in a common record. Database 10→database 12→database 30: Cascading synchronizations will provide caching in multiple databases. Data is replicated in the intermediate database 12.

Synchronization of atomic synchronizations

For each database, the synchronization process stores specific synchronization data in an internal synchronization database (SDB for Synchronization DataBase). Each SDB contains three types of data:

Field Data is data relative to the synchronized fields of one database. Timestamp or unique identifiers are examples of field data.

Database Structure Data (or Meta-Data) are data relative to the structure of database participating to a network of synchronizations (Key definition, fields definition, etc).

Synchronization Data is data relative to all atomic synchronization definitions belonging to a network of synchronizations (synchronization query, field mask, destination record key, etc).

Synchronization Meta Data can be synchronized. In other words, each SDB can know everything about the synchronized table structures and atomic synchronizations belonging to adjacent nodes in the network of synchronization.

It is not necessary to define a synchronization to force the synchronization of the Meta-Data. Meta-Data of a database is synchronized as soon as the database is attached to a network of synchronizations.

Because the structure of synchronized databases (database 10 and database 12) can be published, all the details of the database can be available remotely. This information can be used to define the synchronization. A synchronization definition can be remotely created, changed and removed. The changes can be propagated in real-time, while synchronizations are still running.

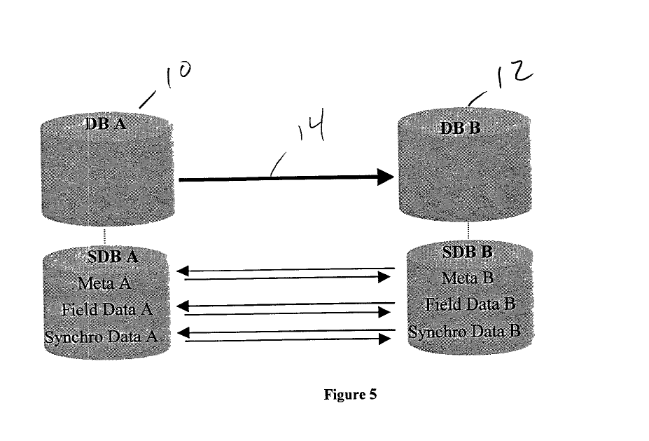

For example, in FIG. 5, it is possible to create from database 12 an atomic synchronization from database 12 to database 10 without having to phone the IT manager of the site A to ask him the structure of the database 10.

The database structure may be changed. The same method can be used to create remote empty databases (auto-create).

For example, two machines A and B linked by a communication channel 14 are participating in a synchronization network. Database 10 is created on machine A, its meta-data appear in database 12. There is an auto-create mechanism creating first an empty database on machine B with the same structure as database 10. From this moment, a default atomic synchronization is initiated from database 10 to database 12. An example of default synchronization could be a synchronization based on a query selecting all fields in database10 so that the database 12 will be a replication of database 10.

Optionally, synchronization information can be merged in one central database to allow centralized management of synchronizations. Any change to a synchronization definition in the central database is forwarded to the involved synchronizations.

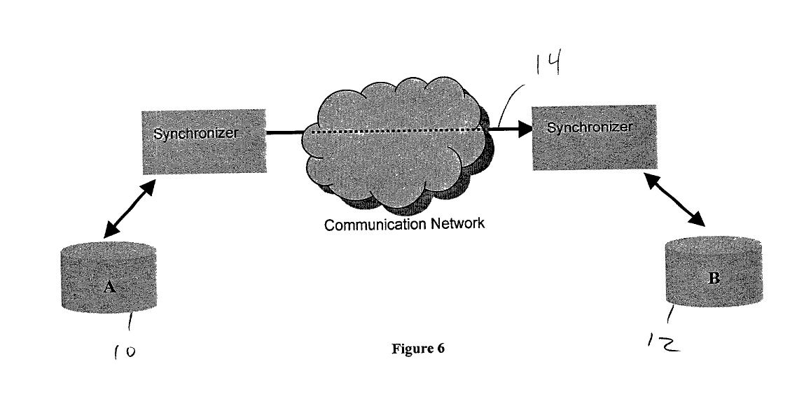

In one embodiment, in order to support any network of atomic synchronizations, the present invention links each database to one synchronizer (see FIG. 6). Each database is preferably only in contact with one synchronizer. A synchronizer can keep information about the database without any modification to the database structure. This allows the system and method to synchronize databases with different formats or structures.

There are many advantages for a decentralized architecture of synchronization information. The load of the synchronization process can be spread over several machines. Each synchronizer can be autonomous and not depend on a central server; it keeps in its SDB (SDB for Synchronization DataBase) up to date information over the DB independently of the status of communication channel.

Synchronization

A synchronizer manages all atomic synchronizations for which its associated database is the source or the destination. It is responsible for all the synchronization data going to or from a given database.

Synchronizers talk to each other through the communication channels. Once the synchronizer has been started, it is ready to communicate with other synchronizers (ports are open) and its local database (opened database). See FIG. 6.

Inside a synchronizer, the processing is generally based on fields of a given record. Within a synchronizer, records are locally identified by a local ID. Within a network of synchronization, records are globally identified by a global ID. The same applies for fields.

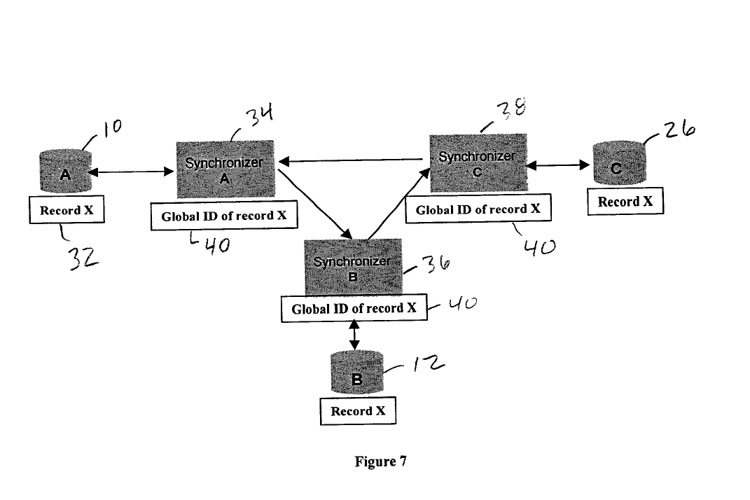

The concept of global ID allows closing a loop in a network of synchronization without duplication of records. For example, in loop database 10→database 12→database 26 presented in FIG. 7, the record 32(X) is present only one time in each synchronizer 34, 36, and 38. Assume that at the beginning a record 32(X) is only present in database 10. A global ID 40 of record 32(X) is assigned to record 32 in synchronizer 34. Because of the synchronizations database 10→database 12 and database 12→database 26, the same global ID 40 is inserted in synchronizers 36 and 38. In the same way, the record 32 is inserted in database 12 and 26. Because of the Global ID 40 which is unique for all the network of synchronization, the synchronization database 10→database 26 will not cause the replication of record 32 in database 10.

Synchronizer tasks

The synchronizer manages atomic synchronizations. It is responsible for outgoing and incoming synchronizations.

Outgoing synchronizations: The synchronizer gets the modified field information from the database. It updates its internal database (SDB), then, if needed, it sends the fields to the other synchronizers. It handles notifications coming from the database. It handles refreshing of data in SDB in case of disconnection from the database (scanning). It handles the scanning requests from other synchronizers.

Incoming synchronizations: The synchronizer gets the modified field information from the other synchronizers (scanning or notification). It updates its SDB (including a track of imported fields), then, if needed, it modifies the fields of the database. It handles refreshing in case of disconnection from other synchronizers (scan). It handles notifications from other synchronizers. It removes non-synchronized fields from database.

The synchronizer, in conjunction with the SDB, uses the stored synchronization information and reuses local data to allow the present invention to transfer only needed data, thus overcoming the heavy burden on a communication channel associated with the direct access model.

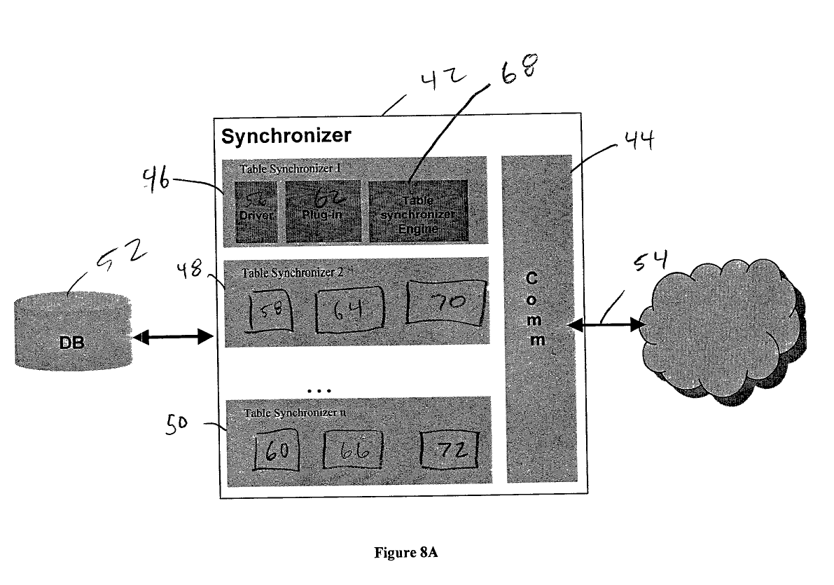

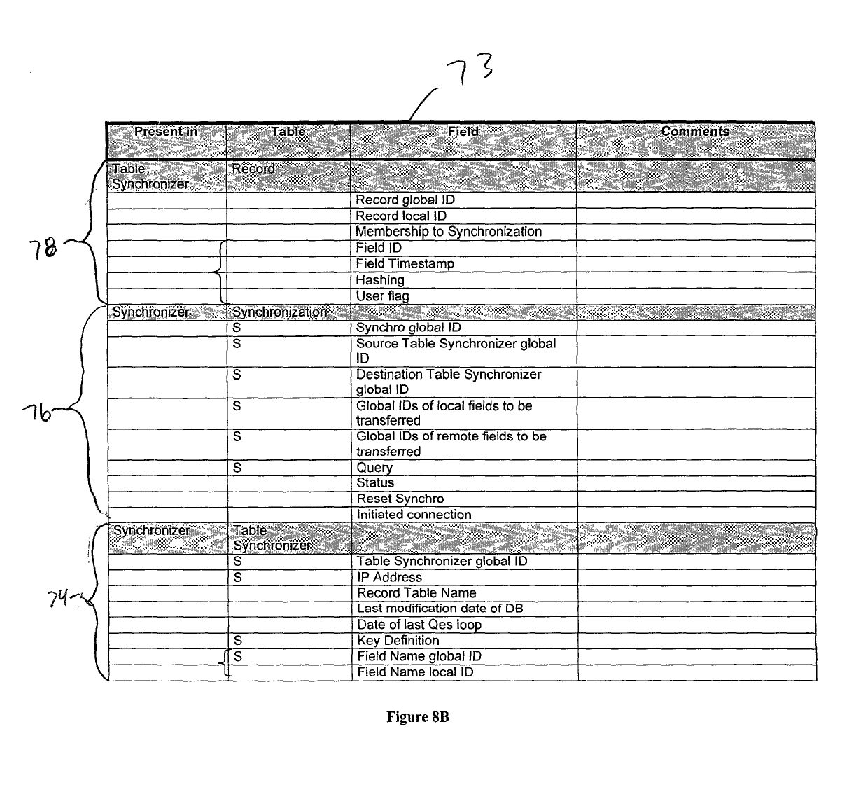

In one embodiment as shown in FIG. 8A, a synchronizer 42 is composed of one communication module 44 and as many table synchronizers 46, 48, and 50 as tables present in the database 52 (see FIG. 8A).

The communication module 44 is the synchronizer interface to the communication channel 54. The communication with other synchronizers is done using the TCP/IP protocol over channel 54.

For outgoing synchronizations, the module 44 is responsible for routing the packets to the right synchronizers while for incoming synchronization, the module 44 routes the packet to the right table synchronizer engine.

Table synchronizers 46, 48, and 50 manage atomic synchronizations on fields presented by the respective drivers 56, 58, and 60 in the logical tables of the synchronizers 46, 48, and 50. Table synchronizers 46, 48, and 50 manage all the atomic synchronization going to or coming from the logical tables. Table synchronizers 46, 48, and 50 are each composed of a driver 56, 58, and 60, a plug-in 62, 64, and 66 and a table synchronizer engine (sync. eng.) 68, 70, and 72, respectively. Any multiple of table synchronizers can be present in one synchronizer.

Drivers 56, 58, and 60 are the specific database interfaces. This layer is preferably as thin as possible and is a variable part of the table synchronizer because it depends on the type of database it is accessing. There is one driver for each plug-in. The drivers enable the present invention to synchronize databases with different formats or structures, thus overcoming a problem associated with conventional methods.

Drivers 56, 58, and 60 are also responsible for presenting data from the database 52 in a coherent manner. In fact, it presents the data in logical tables so that fields are present in one logical table only.

Plug-ins 62, 64, and 66 handle the generic database communication for its logical table. There is one plug-in per table synchronizer.

Plug-ins 62, 64, and 66 are the unique accesses to the logical table of the synchronizer 42. They have read/write access to the database 52 and the local SDB. Plug-ins 62, 64, and 66 exchange packets with the local table synchronizer engine. Because all the information contained in the packets are in the database format, this information is generic.

Table synchronizer engines 68, 70, and 72 handle the synchronization management for their respective logical table. There is one table synchronizer engine per table synchronizer.

Table synchronizer engines 68, 70, and 72 have access to the local SDB. They communicate locally with their respective plug-in 62, 64, and 66, with other table synchronizer engines running on the same database 52 and with remote table synchronizer engines located on other machines (via the module 44). From the table synchronizer engine point of view, the plug-in acts just like a “local” table synchronizer engine.

The synchronization database (SDB) 73 is storing all the information needed by the synchronizer and table synchronizer. It is divided in three table definitions (see FIG. 8B).

The first one, the record SDB (Rec-SDB) 78 contains information about synchronized records (IDs) of the database and about their associated fields (IDs, Timestamps, hashing and user flag). Information about fields is multi-valuated: for one SDB field of type “record” (for example Record Global ID) may correspond to several SDB fields of type “field” (for example, Field ID).

The second one, the Synchronization SDB (Synchro-SDB) 76 contains the definition of the atomic synchronization running in a given synchronizer. This is information about the synchronization itself (Synchro global ID, Source Synchro Global ID, Destination Synchro global ID, Global Ids of local field to be transferred, Global Ids of remote fields to be transferred, Query) and the status of the synchronization (Status, Reset Synchro and initiated Synchro).

The last one, the table synchronizer SDB (TSyzer-SDB) 74 contains the definition of the local and adjacent Table Synchronizers (Table synchronizer global ID, IP address) but also information about the structure of the table (meta-data) (Key definition, Field name global IDs, Field name local IDs) and other information about the database Table to synchronize (Record Table Name, Last modification date of DB).

There is one TSyzer-SDB and one Synchro-SDB per Synchronizer and one Rec-SDB per Table Synchronizer.

Initialization phase between two synchronizers

As previously mentioned, synchronization definition and meta-data are synchronized between adjacent synchronizers. The fields synchronized as marked with an “S” in FIG. 8B. It means that in each synchronizer, a first Table synchronizer will be responsible for the synchronization of Table synchronization definitions and another second Table synchronizer will be responsible for the synchronization of Table Synchronizers definitions. These two Table synchronizers are called “system” Table Synchronizers.

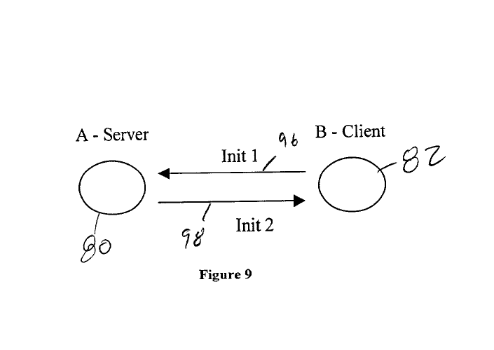

This paragraph describes how the communication between two synchronizers is initiated. The global process is presented in FIG. 9.

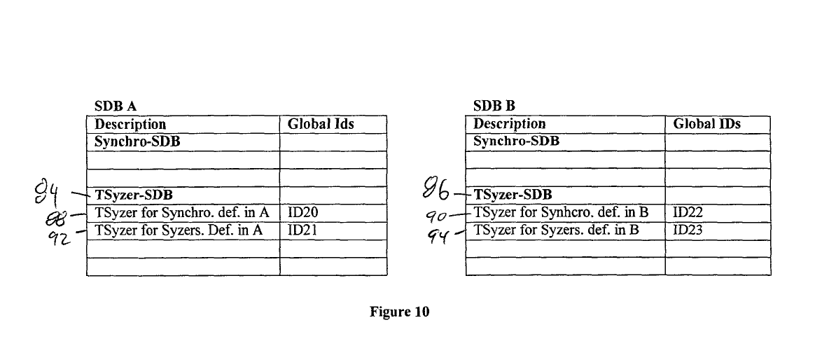

In this example, there are two synchronizers A (Server) 80 and B (Client) 82. In each of TSyzer-SDBs 84 and 86, there is one record representing the Table synchronizer synchronizing the synchronization definitions 88 and 90 and a second one representing the Table synchronizer synchronizing the Table synchronizer definitions 92 and 94 (see FIG. 10). Those records are called system records. Initially, synchronizer 82 requests a connection to synchronizer 80. The client 82 sets a TCP/IP connection 96 with the server 80. The server 80 accepts the connection and opens a second connection 98 from server 80 to client 82. The client 82 sends a first “init” packet containing Global IDs of its two Table Synchronizers. The server 80 receives the packet and decides to establish the communication. If it refuses the connection, it closes the TCP/IP connection 96.

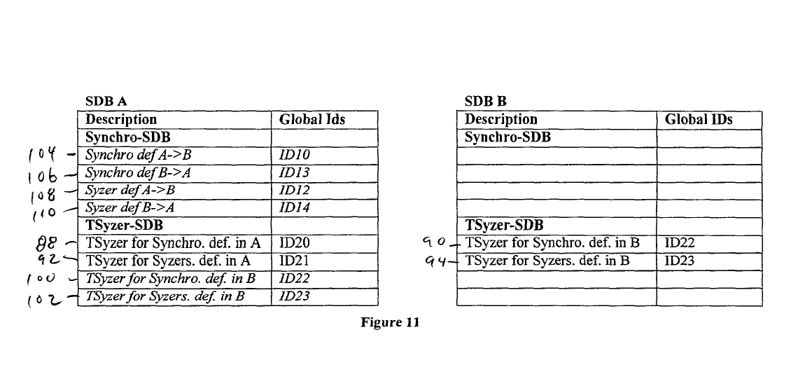

The server 80 adds two system records 100 and 102 in its TSyzer-SDB representing the two remote system Table Synchronizers of client 80. It also adds four system records 104, 106, 108, and 110 representing the four synchronizations between the two system Table Synchronizers 88 and 92 in server 80 and the two system Table Synchronizers 90 and 94 in client 82 (two in one way, two in the other way) (see FIG. 11). Those synchronizations are called system synchronizations.

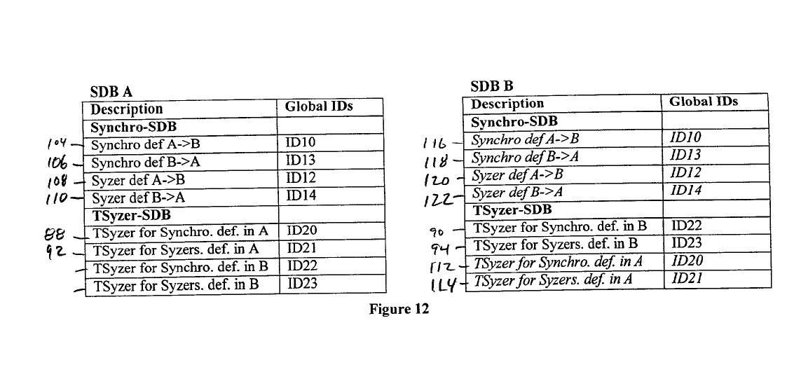

The server 80 sends to the client an init packet 2 with global IDs of its two system records 100 and 102 representing Table synchronizers and global IDs of the four records 104, 106, 108, and 110 representing the system synchronizations. The client 82 receives the packet and adds these six records 112, 114, 116, 118, 120, and 122 in its SDB (see FIG. 12).

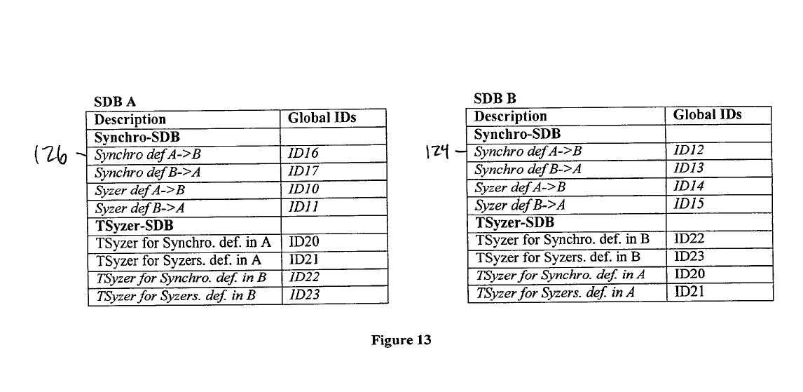

Problems arise if the init packets cross each other. For example, assume that at the same time client 82 sends an init packet 1ab to server 80 and server 80 sends an init packet 1ab to client 82. The FIG. 13 presents the situation after the reception of the packets.

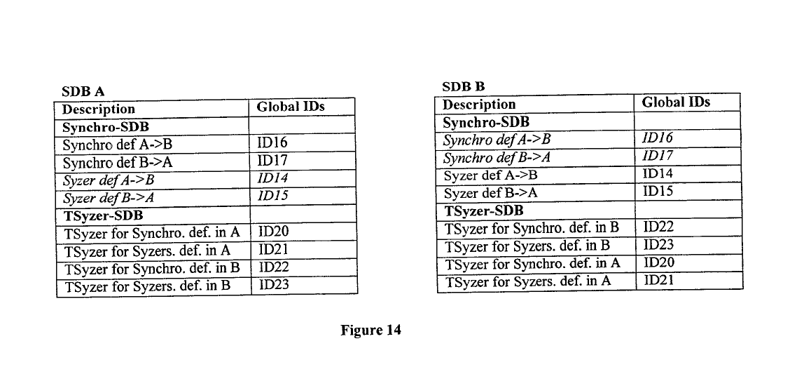

After the reception of the packet 1ab, client 82 is sending an init packet 2ba while server 80 is sending an init packet 2ab each containing global IDs of its two system records representing Table synchronizers and global IDs of the four records representing the system synchronizations. To avoid the duplication of the four system records of synchronization definition in A and B, the records with global IDs already present in SDB are replaced by records arriving if the their global ID is inferior to the corresponding record arriving in packet 2. For example, the record “Synchro def A->B” 124 with ID12 in client 82 will be replaced by the record “Synchro def A->B” 126 with ID16 coming from server 80. The situation after the reception of the two packets 2 is presented in FIG. 14.

In this example, the system records are not synchronized. If needed, they are removed after a timeout.

Start/Stop of synchronizations

A synchronization may be active or disable. A synchronization is active if its destination Table Synchronizers is ready to receive data. If the destination Table Synchronizers is not ready, the atomic synchronization must not ask its source table synchronizer to send data through the communication channel. As soon as the destination Table Synchronizers is ready, it sends a start packet to inform the source table synchronizer that it may sends data concerning the synchronization.

Table Synchronizer Subcomponents

The table synchronizer, through its subcomponents, in conjunction with the SDB, allows the present invention to combine overlapping queries to cut down the amount of access to the local database, thus overcoming a disadvantage associated with conventional synchronization models.

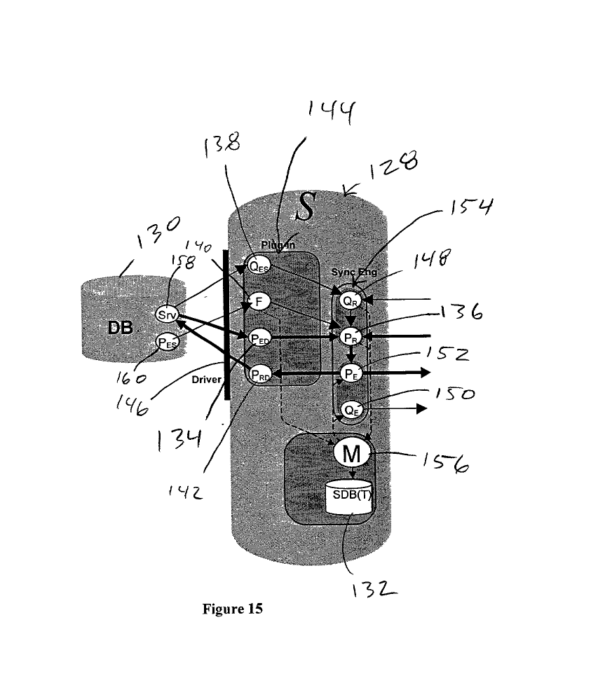

A table synchronizer 128 with its subcomponents is represented in FIG. 15. There are two main types of subcomponents: Q and P. Q subcomponents manage Queries made on database 130 and SDB 132 while P subcomponents manage Packets exchanged during a synchronization process.

Hereinafter, the Q and P subcomponent are associated with two subscripts (E or R) indicating if the subcomponent emits (E) or receives (R) data from other subcomponents. Subcomponents of same type with subscript E (R) emits (receives) data to (from) components with subscript R (E). For example Ped 134 emits data to Pr 136, Pr 136 receives data from remote Pe (Pe of another Sync. Engine).

Subcomponent are separated into different groups: Qes 138, F 140, Ped 134 and Prd 142 are part of the plug-in 144. They are responsible of generic interaction with the database 130 through the driver 146.

Qr 148, Qe 150, Pr 136 and Pe 152 are part of the synchronizer engine 154. They provide the link with the other synchronizers and their database is SDB 132.

M 156 and SDB 132 are part of the internal database system of the synchronizer 128.

Srv 158 represents the Data Base server and Pes 160 the notification server of the DataBase 130.

Subcomponents exchange packets between each other. Generally one packet is sent for information about one record. They do so inside a given synchronizer or between different synchronizers.

For the flow of a packet, there are three modes:

Normal: (the default mode). Arrows in FIG. 15 indicate the flow of normal packets.

Request: in this mode, packet are going in the opposite direction as for a normal packet.

Request response is a normal packet but without filtering by Pr 136 and dispatching by Pe 152.

A packet contains information about: Records, Record ID, Synchronization membership, Hashing of timestamps, Fields, Field ID, Value, and Timestamp.

Flags can be used to indicate the type of packet:

Request

Response to a request

Reset

End of cycle

Start

Stop

A packet might contain only a subset of this information. The formats possible for a packet are:

“Basic”: Record ID+synchronization membership;

“Hashing”: “Basic” +a hashing calculated on all fields participating to synchronization (A hashing function is a function compressing the information. A hashing is not reversible: it is not possible to retrieve the initial value from a hashing on this value.);

“Fields”: “basic” +field Ids;

“Timestamps”: “Fields” +fields timestamps; and

“Data”: “Timestamps” +field values.

They are two mode for Qes 138: the scanning detection method where the goal is to update both the timestamps and the membership to synchronization and a light scanning detection method where Qes only check for synchronization membership.

As already mentioned, the scanning method is used both for the initializing phase and when notification is not available. The start of a synchronizer or the change of a query when notification is used are events demanding an initializing phase. Qes 138 loops through the record only when needed. That is when notification is inactive (because the database does not support it or because the channel is closed) or when the data integrity needs to be restored (after a lost of connection or an error).

Qes is running in light scanning method is used when timestamps are fields contained in the DB itself. In this case, the implementation is lighter because, Qes 138 does not need to estimate the timestamps.

Inside a Synchronizer Table, the main role of Qes 138 is to estimate timestamps associated with fields that have been modified in the DB 130. Qes 138 is based on a loop considering all queries defined in a table synchronizer. From the resulting records, it selects all fields participating to atomic synchronizations. Qes 138 analyzes each relevant field separately.

Qes In/out

In:

From Srv 158, Internal Key value (if relevant)+timestamps (if available) or Internal Key value (if relevant)+Fields value. An internal key is a key generated by the DB 130.

Out:

to Qr 148, Basic packet with flag reset

to Qr 148, Basic packet with flag end of cycle

to Qr 148, data packet

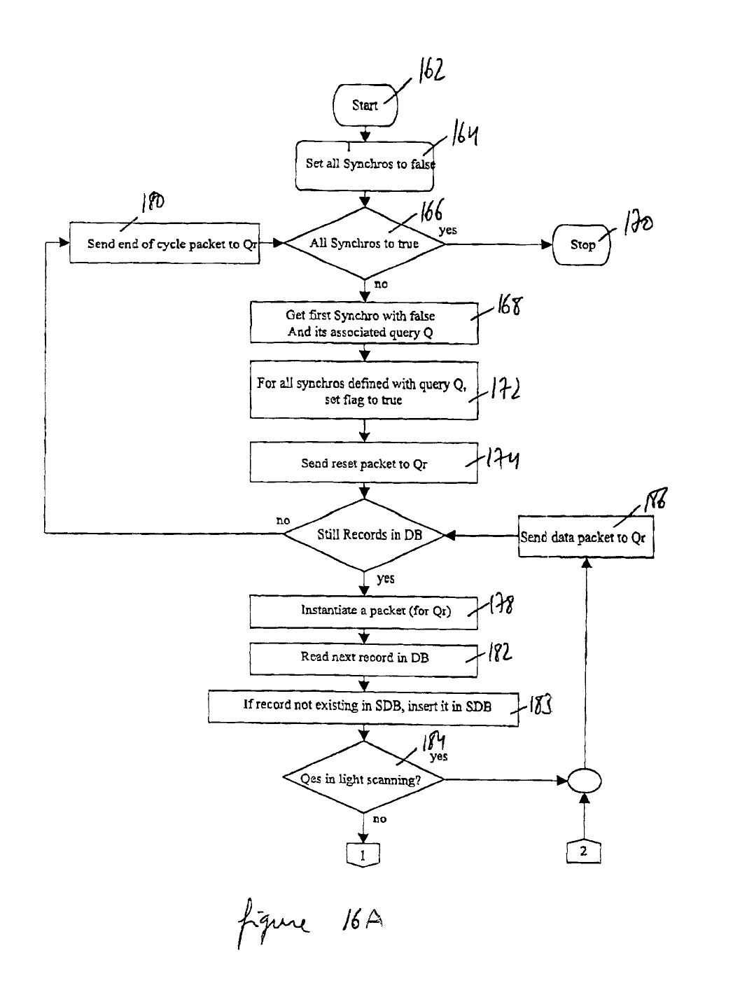

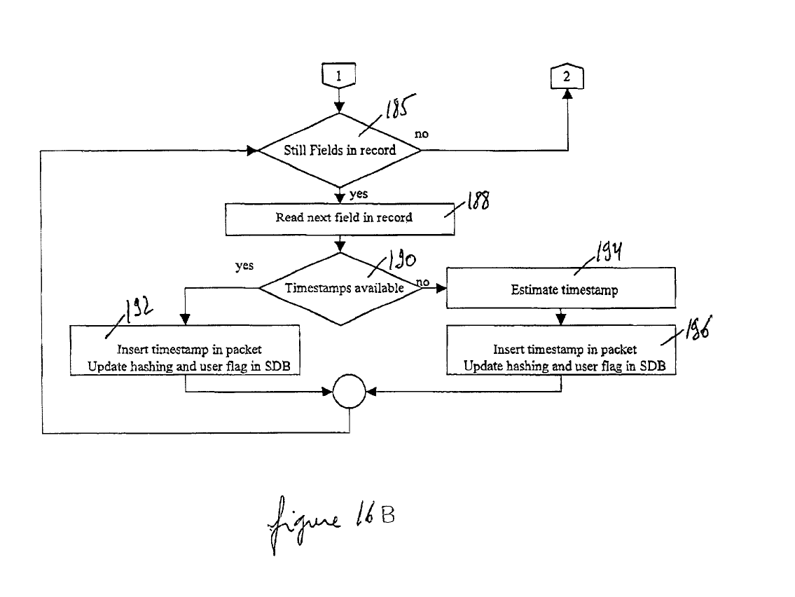

The steps of the Qes 138 algorithm are (see FIGS. 16A and 16B):

Step 162, a “Qesloop” flag is attached to each synchronization. Step 164, the Qesloop flag is set to false for the set S of synchronizations attached to a given table synchronizer.

Step 166, determine if at least one synchronization has the flag to false. If at least one synchronization has the flag set to false, proceed to step 168, otherwise proceed to step 170 and stop.

Step 168, get the first synchronization S1 in S with flag to false and read in SDB 132 the Query Q associated with S1.

SQ is the set of atomic synchronizations having the same query Q as synchronization query.

Step 172, read in SDB 132 the set SQ of synchronizations with Query Q as query and put all flags to true for those synchronizations.

Step 174, send a basic packet with flag reset to Qr 148 to indicate the start of the treatment of a query.

Step 176, if there are still records in DB 130 found with query Q, proceed to step 178, otherwise proceed to step 180.

Step 178, Qes creates a packet.

Step 182, read next record in DB 130.

Step 183, if record does not exist yet in SDB 132, create it in packet to Qr, put membership to true for source synchronizations of SQ. For a record, a membership to a given synchronization set to true indicates that this record is participating to the synchronization.

Step 184, if Qes is in mode “notification with timestamp managed by DB” proceed to step 186.

Step 185, treat each record fields of the synchronization field mask. If there is still records to treat, proceed to step 188, otherwise to step 186.

Step 186, send the packet to Qr 148.

Step 188 consider the next field to treat. Add field ID in packet to Qr 148.

Step 190, determine if timestamps are present in the packet. If yes, proceed to step 192, otherwise proceed to step 194. The presence of timestamp depends on the capacity of DB 130 to generate timestamps.

Step 192, if timestamp received from DB 130 is more recent than the timestamp in SDB 132, put the timestamp received from DB 130 in packet. Otherwise, put a predefined value “OldestValue” in the packet. The Oldest Value is the oldest value known by the synchronization system.

If needed Update hashing function in SDB 132 and the user flag (In fact, the writing in SDB 132 does not have to occur immediately. Qes 138 can wait for an acknowledgement (more precisely a return on function) confirming that the packet has been correctly sent by Pr 136.)

Step 194, if timestamps are not available, calculate a hashing value on the value received from the DB 130 and compare it with the hashing value in SDB 132.

If the hashings are different, Qes 138 estimates (Qes 138 bases its estimation on the fact that the modification has occurred sometimes between the start of the previous Qes 138 loop and the current time) the timestamp and puts it in the packet to Qr 148. If the hashings are the same, it sends the pre-defined “OldestValue” in the packet to Qr 148. If needed Qes 138 updates hashing function in SDB 132 and the user flag (In fact, the writing in SDB 132 does not have to occur immediately. Qes 138 can wait for an acknowledgement (more precisely a return on function) confirming that the packet has been correctly sent by Pr 136.)

Step 186, when all the field of a given record have been treated, send the packet to Qr.

Step 180, when all the synchronizations of SQ have been considered, send a end of cycle packet to Qr

A filter (F) 140 receives a notification for any modification, creation or suppression. This notification is generated directly by the database 130 or by a query made on modification tags in the database records.

The filter 140 checks the field membership to any atomic synchronization in SDB 132. Filter 140 generates and sends packet to Pr 136 containing only information for fields participating in one atomic synchronization at least.

A packet sent by F 140 to Pr 136 contains: field value, field timestamp (equal to current synchronization time) and synchronization membership.

The filter 140 sets the timestamps in the packet.

If needed, F 140 updates the hashing value in the SDB 132.

Filter In/Out

In from Srv: 158, a record with all field values and the list of modified fields (timestamps=current time). The internal key (if relevant)

Out to PR 136, a packet with modified or inserted field values and timestamps and synchronization memberships.

Filter

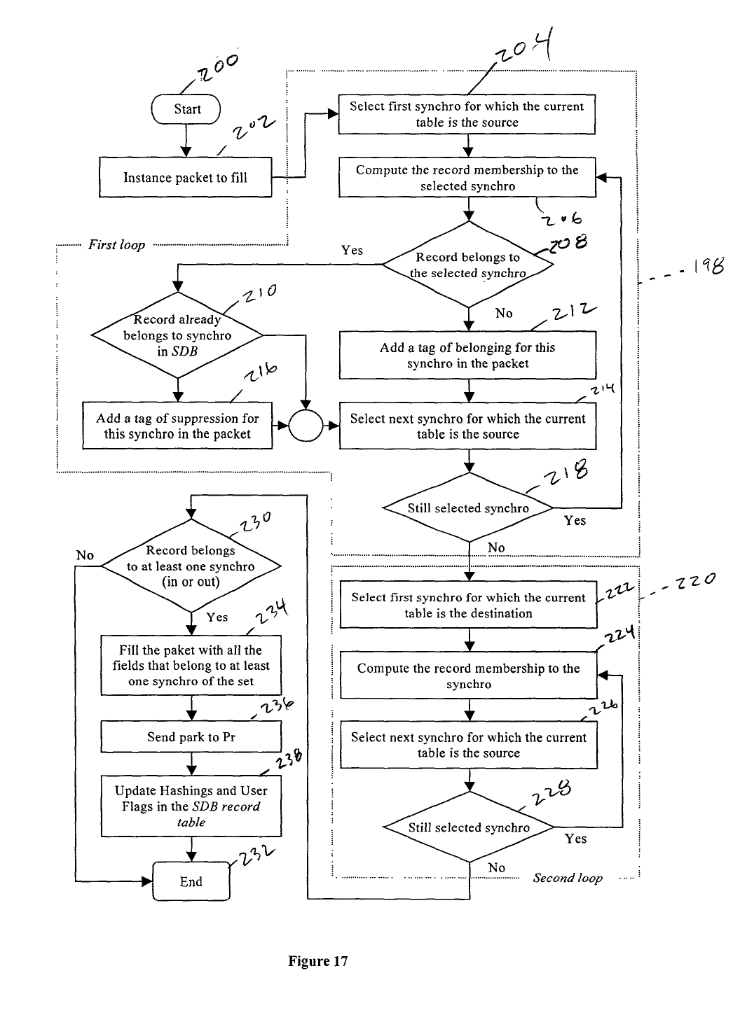

Filter 140 algorithm is shown in FIG. 17.

Step 202, create a packet. This is the packet in which the changed fields of the current record will be added. Create a empty vector S of Synchro Global ID. This vector will contain all the Synchro Global IDs to which the record belongs. Use in step 234

The first loop 198 describes outgoing synchronizations. Outgoing synchronizations are synchronizations for which the current table is the source. This first loop 198 determines to which outgoing synchronizations the record belongs.

Step 204, select first synchro for which the current table is the source. Step 206, compute the record membership of the selected synchro from the values in the record Step 208, determine if the record belongs to the synchronization by determining if the record is selected by the definition query of the synchronization. If it does, proceed to step 210, otherwise proceed to step 212.

In step 212, notification of a modification is made by adding a tag of belonging to the synchronization in the packet. Add the Synchro Global ID to S. If the record does not exist in the SDB record table of the Table Synchronizer, get a new Record Global ID and create a entry in the SDB record table for the new record. Otherwise, if the record would belong to the synchronization in the SDB record table, add a tag of suppression to the synchronization in the packet and add the Synchro Global ID in S, step 216. Otherwise, it has already been eliminated or has never belonged to the synchronization.

Second Loop 220 describes incoming synchronizations.

Steps 222, 226 and 228—Loop implementation. For each synchronization for which the table is the destination:

Step 224, calculate the belonging to the synchronization from the values in the record. If the record belongs to the synchronization, add the Synchro Global ID in S.

Step 230, if S is not empty (That means there exists a tag of belonging or suppression in the packet or if the record belongs to at least one incoming synchronization), proceed to step 234.

Step 234, add the Record Global ID to the record in the packet.

In step 234, for each, add the Synchro Global ID in S.

Step 234, for each field belonging to the current synchronization: if not already in the packet and if the timestamp in the record is more recent than the timestamp in the SDB, find the Field Name Global ID from the File Name Local ID, add the field value, the Field Name Global ID and the timestamp of the packet, and if this is not already the case, put the flag user to true in the SDB 132 record table of the fields.

Step 236 Send the packet to PR 136.

Step 238, PRd 142 writes (creates or deletes) fields in DB 130 on request of Pe 152 and updates hashing values in the SDB 132 accordingly if the write operation in the DB 130 was successful. The SDB 132 must perfectly reflect the state of DB 130. Thus, if the writing in DB 130 fails, the SDB should not be updated. To find the destination record, Prd 142 reads in SDB 132 a definition of the key record destination.

Prd 142 handles two types of request, in and out. For in requests from Pe 152, a packet with modified field values with their timestamps is received. For out requests to Srv 158, a record with modified fields and their timestamp (if relevant), and the identification key is sent.

Prd

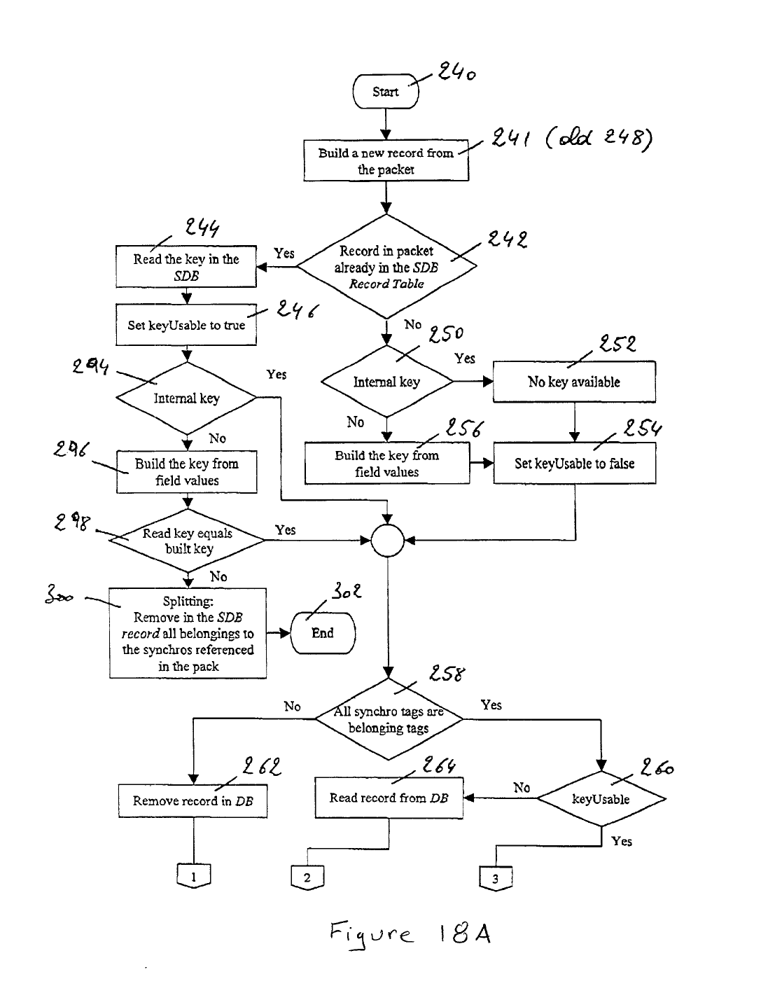

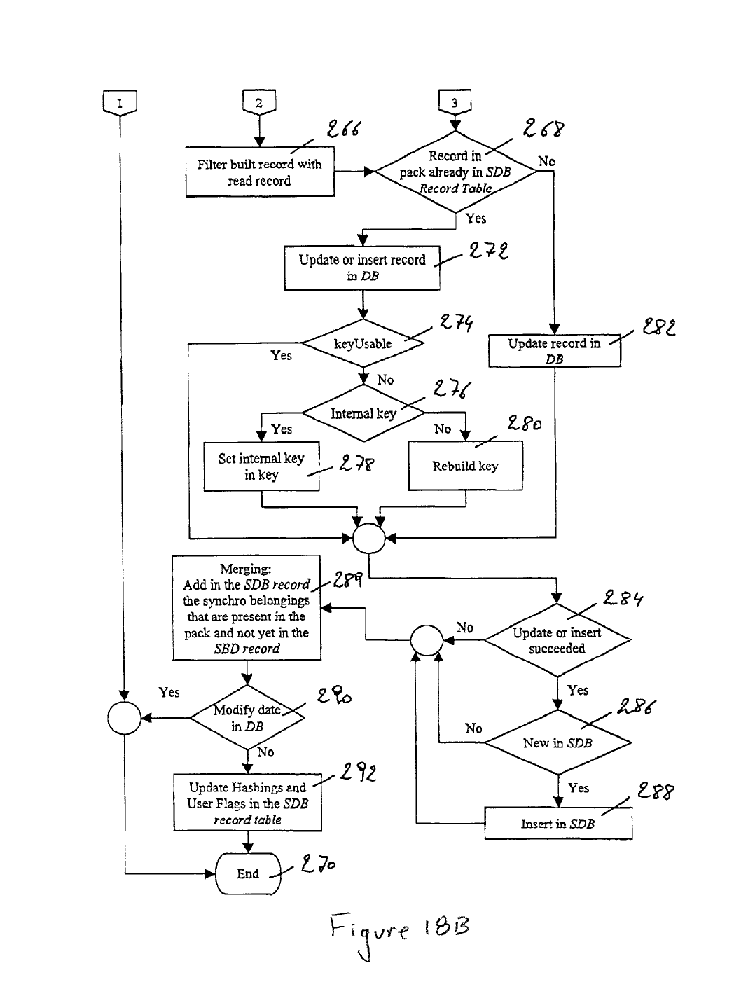

Prd 142 algorithm is shown in FIGS. 18A and 18B.

Step 240, a packet coming from the Pe 152 containing a Record Global ID (zero =new record in the SDB 132) and the field values with their Field Name Global ID and their timestamp as well as the membership of synchronizations is received by Prd 142.

Step 241, create a new record=newRecord. For each field in the structure: convert the Field Name Global ID into Field Name Local ID, convert the Field Name Local ID into an index from the view (which is determines the structure of the record), and place the value in the record at the position pointed out by the index.

Steps 242 to 256, involve calculation of the key.

Instance flag key Usable

Step 242, if Record Global ID=zero ( [symbol] =>record not yet in SDB), proceed to step 250.

Step 250, if we are not working with the internal key, proceed to step 256.

Step 256, build a value of key from the record.

Step 254, Key Usable←false

Step 242, if record is in the SDB, proceed to step 244.

Step 244, read the value of the key in SDB.

Step 246, KeyUsable←true.

Step 294, if we are not working with the internal key, proceed to step 296.

Step 296, build a value of key from the record.

Step 298, if the read key and the built key are not the same, proceed step 300

Step 300, splitting: remove in the SDB record all belongings to the synchros referenced in the pack. Set the recordIDw to zero in the pack to force the re-entrance in Prd as a new record.

Step 302, return true.

In step 258, identification of the synchronizations and of the type of operation (Insertion, modification, suppression): if all the synchronization tags are belonging tags, it is about a modification/insertion.

Otherwise, if all the synchronization tags are suppression tags, it is about a suppression.

Otherwise, there is a failure and a Return false is generated.

Step 258, if modification/insertion, (do not apply modification if suppression, because modification and suppression separated at the kernel level), proceed to step 260.

Step 260, if keyUsable=true, proceed to step 268.

In step 264, create a new record=oldRecord.

Step 264, read the record in the DB from the key (coming from the SDB) and place the outcome into oldRecord.

Step 266, for each field in the view: if the field contains a value in the new record, calculate the value of hashing of the field in oldRecord. If different, then of the value in the SDB (modification in the DB not yet reflected in the SDB via F or QES) or if the date of modification into the oldRecord more recent than the newRecord, delete the field in the newRecord.

Step 268, if the record is new in the SDB, proceed to step 272.

Step 272, if not working with the internet key and update of the record from the value of the key and the new record failed, insert a new record from the value of the key of the newRecord.

Step 274, if keyusable=false, proceed to step 284.

Step 276, if use of the internal key, proceed to step 278.

Step 278, place the received value after writing in the value of the key.

Step 280, rebuild the value of the key from the newRecord of which the values have may be been truncated during the writing.

Step 282, update the record from the key value of the newRecord.

Step 284, if the update or insertion of the record has been done, proceed to step 286.

Step 286, if the file is new in the SDB Record Table, proceed to step 288.

Step 288, add a new entry in the record table and place there the Record Global ID and the key value.

Step 289, Merging: add in the SDB record the synchro belongings that are present in the pack but not yet in the SDB record.

Step 290, if there are no timestamps in the DB 130, proceed to step 292.

Step 292, for every field received: if the entry for this field does not exist in the SDB record, create a new entry. Otherwise, if the hashings are different, update the fields table.

Step 262, delete the record from the key value and add the Record Global 1D to the packet.

Step 270, return true.

Ped

Ped 134 reads fields in the DB 130.

Ped 134 updates the hashing function (if needed and if the associated packet has been successfully passed to the communication channel).

Ped 134 receives packets in from Pr 136. The packet contains a list of request fields (without values). Ped 134 sends out to Pr 136 a packet with the request values read in the DB 130.

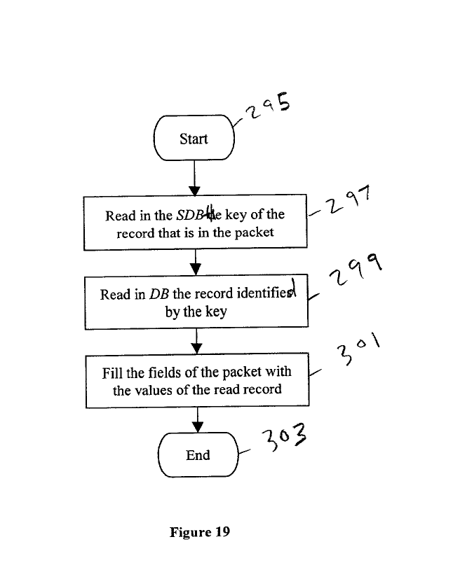

The steps of the Ped 134 algorithm are shown in FIG. 19.

Step 295, Ped 134 receives a packet from Pr 136 containing the Record Global ID, the Field Name Local IDs and the Synchro Global ID.

Step 297, Ped 134 searches in the SDB 132 record table of the plug in 144 for the key of the record from the Record Global ID.

For every Field Name Global ID

In step 299, search the Field Name Local ID corresponding in the SDB 132 synchronizers table. Ped 134 is making a request to the DB 130 with this key for these Field Name Local 1D. Ped 134 receives a view of a record coming from the DB 130. This view contains the key and a set of the fields with their ID (Field Name Local ID).

For every field:

Step 301, add the value of the record in the packet, stamp the packet nonfilterable, and pass the structure at PR 136. This stamp indicates to Pr that the packet is a response to a request. Qr 148 works only with Qes 138 and a remote Qe. This is the receiver component for all loops scanning all records in a DB 130 or in the SDB 132. Its main purpose is to update in the local SDB 132 the records belonging to synchronizations.

The main difference between Qes 138-Qr 148 and remote Qe-Qr 148 communications is that the second is remote, and thus remote Qe sends more compact packets (hashing format without values) but if a record has been changed, Qr 148 sense a request and will receive the answer with dates.

Qr

Qr 148 receives in from remote Qe four types of packets:

basic format with reset flag;

basic format with “end of cycle” flag;

hashing format; and

date format.

Qr 148 receives in from Qes 138 packets in a data format (unchanged fields have a coded date). Qr 148 sends out packets to remote Qe in date format with request flag. Qr 148 sends out packets to Pr 136 in data format or date format.

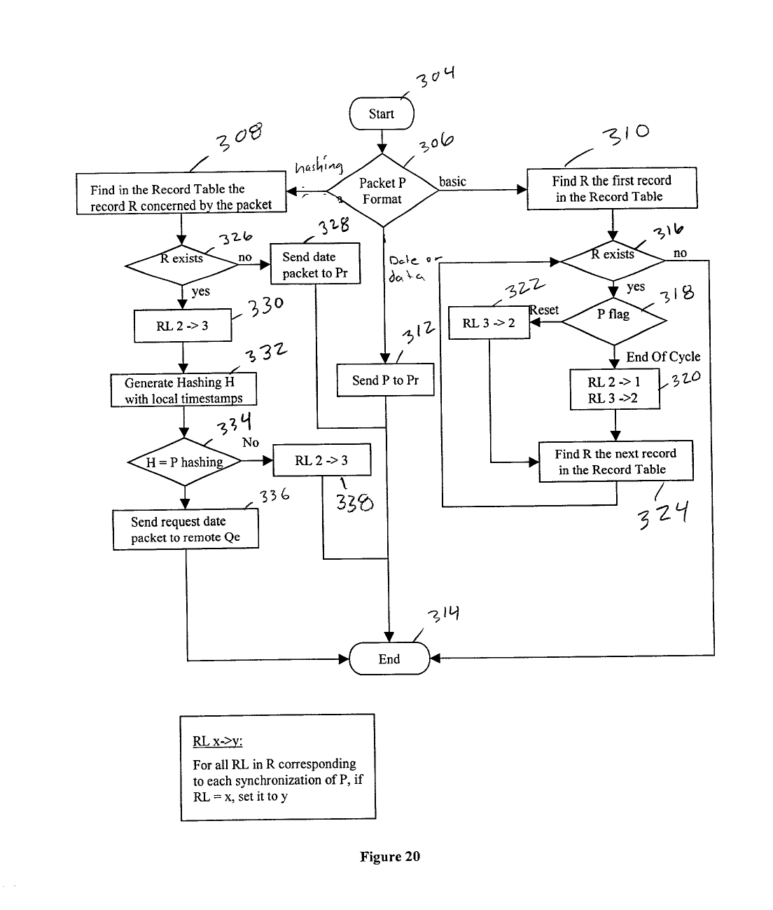

Qr 148 algorithm is shown in FIG. 20. For this example, let P be the incoming packet which content can be one among those described above. Step 304, the Qr 148 process starts when it receives P. Step 306, determine the format of packet P. If the packet P is in hashing format, proceed to step 308. If the packet P is in basic format, proceed to step 310. If the packet P is in date or data format, proceed to step 312.

Step 312, Qr 148 sends packet to Pr 136 and ends process in step 314.

Step 310, Qr 148 searches the first record R in the records table in the SDB 132 and all refresh levels in R corresponding to each synchronization of the packet. Step 316, determine if R exists in SDB 132. If not, proceed to step 314 and end process. If R exists, proceed to step 318.

Step 318, determine if the packet flag is “reset.” If not (flag is “end of cycle”), proceed to step 320. If packet flag is “reset,” proceed to step 322. Step 320, decrement RL by one if it is at two or three and proceed to step 324 (Note: RL 2 is just an intermediate level. Each record that does not belong anymore to any synchronization is not send to Qr 148. This record's RL is still 2 before Qr 148 receives the “End of cycle” packet, and it will reach 1 after processing. RL≦1 means that the record doesn't belong anymore to a synchronization.) Step 322, set RL to two if it is at three and proceed to step 324. Step 324, search for next R in SDB 132 and proceed to step 316.

In step 308, Qr 148 searches SDB 132 for R in the record table of the record R in the packet. Step 326, determine if R exists in the record table of SDB 132. If not, proceed to step. If it does exists, proceed to step 330. In step 328, Qr 148 creates a new packet P2 (“date” format without flag) with the same fields as P with all dates set to 0, sends P2 to Pr 136, and ends the process in step 314.

In step 330, if RL equals two, RL is set to three and proceed to step 332.

Step 332, Generate a hashing H with the timestamps in R of all the fields corresponding to those related in P.Step 334, if H=the hashing in the packet, proceed to step 336. Otherwise, proceed to step 338. Step 336, Qr 148 creates a new packet P2 (“request” flag, and “date” format) with the same fields as P, sends P2 to remote Qe, and ends process in step 314. Step 338, RL is set to 3 and the process ends in step 314.

Qe 150 will loop through all the records of the SDB 132 that are synchronized (outgoing) and send the timestamps to a remote Qr (Qr'). To minimize communication, it sends a hashed value of the time stamps of all the synchronized fields. However, on request of Qr', it can send a packet with individual timestamp of fields.

Qe 150 receives from remote Qr a field packet with “request” flag. Qe 150 sends to remote Qr a hashing packet or timestamps packet or basic packet with “reset” flag or basic packet with flag “end of cycle.”

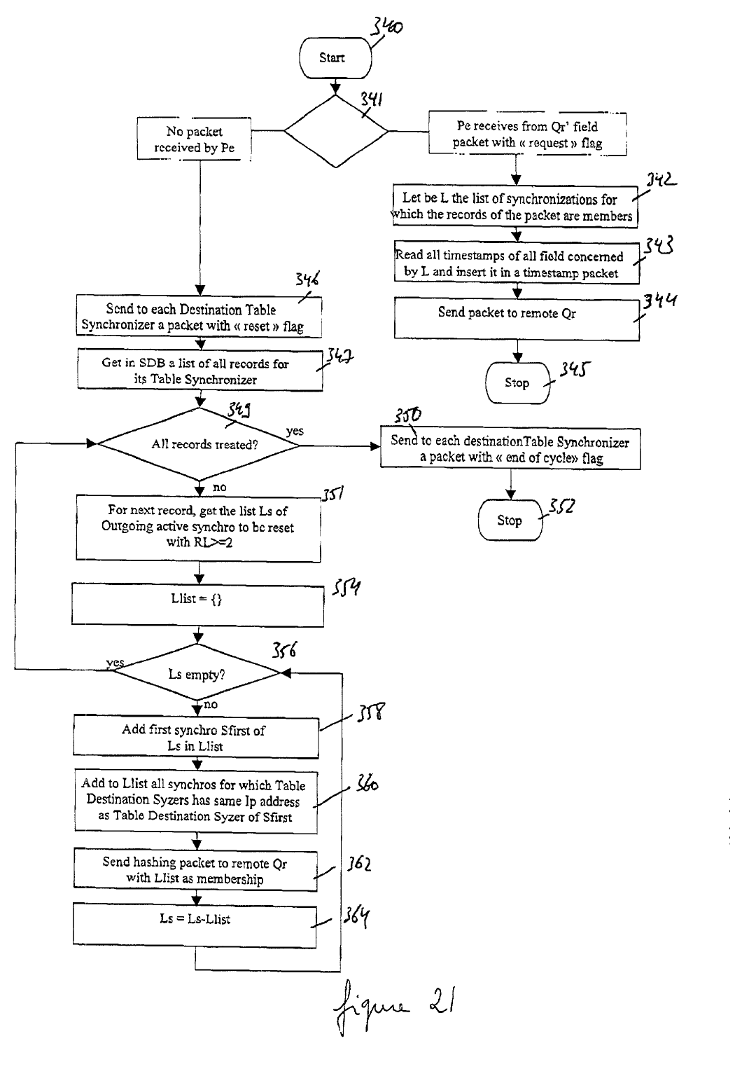

The Qe 150 process is shown in FIG. 21.

Step 340, start of the process of Qe 150.

Step 341, if Qe 150 receives from remote Qr field packet with “request” flag, proceed to step 342 If Qe 150 does not receive packet, proceed to step 346.

Step 342, L is the list of synchronizations stored in SDB 132 for which the records of the packet are members.

Step 343, Qe 150 reads in SDB 132 all the timestamps of all the field associated with L and sends insert them in a timestamps packet without flag

Step 344 Qe 150 sends the timestamp packet to remote Qr.

Step 346, Qe 150 initiates the loop and sends to each destination table synchronizer a basic packet with “reset” flag.

Step 347, Qe 150 gets a list of all records for its Table Synchronizer. For all records in the list, Qe 150 performs the following process.

Step 349, Qe 150 determines if all records in the list have been treated. If not, Qe 150 gets next record R in list and proceed to step 351. If yes, Qe proceeds to step 350. Step 350, Qe 150 sends to each destination Table Synchronizer a packet with “end of cycle” flag and ends to the process in step 352.

Step 349, Qe 150 gets from record R the list of synchronization for which the membership is put at true in R and put in List Ls of synchronizations only outgoing active synchronizations to be reset with RL>=2.

Step 354, Qe 150 sets Llist to empty. Step 356, Qe 150 determines if Ls is empty. If yes, proceed to step 349. If no, proceed to step 358. Step 358, Qe 150 adds first synchronization Sfirst in Ls to Llist. Step 360, Qe 150 adds to Llist all synchronizations for which Table Destination Synchronizers has the same IP address as the Table Destination Synchronizer of Sfirst. Step 362, Qe 150 calculates a hashing on all fields timestamps participating to one synchronization at least, puts this hashing in a hashing packet, sets membership to the synchronization corresponding to Llist, and sends hashing packet to remote Qr with Llist as membership. Step 364, Qe 150 removes Llist from Ls and return to step 356.

Pr

Pr 136 centralizes the reception of the packet in the synchronizer 128 and resolves the conflicts. Conflicts appear when the synchronization must apply a modification on a field that has been modified by the user since last synchronization. Conflict resolution is a method to decide which data will remain on both sides. In one embodiment, the synchronization model solves the conflict by keeping in the packet field a more recent value. All field information in the incoming packet that is older than local one is removed.

Pr 136 updates timestamps and synchronization memberships in the SDB 132 and can send request packets for the missing values.

Pr 136 receives from Qr 148 packets in date or data format. Pr 136 receives from Ped 134 packets in data format with “request” flag. Pr 136 receives from Pe 152 packets in data format with “request” flag. Pr 136 receives from F 140 packets in data format. Pr 136 receives from a remote Pe packets in data format with “request” flag.

Pr 136 sends to Ped 134 packets in data format with “request” flag. Pr 136 sends to Pe 152 packets in data format (with or without “response” flag). Pr 136 sends to a remote Pe packets in date format with “request” flag.

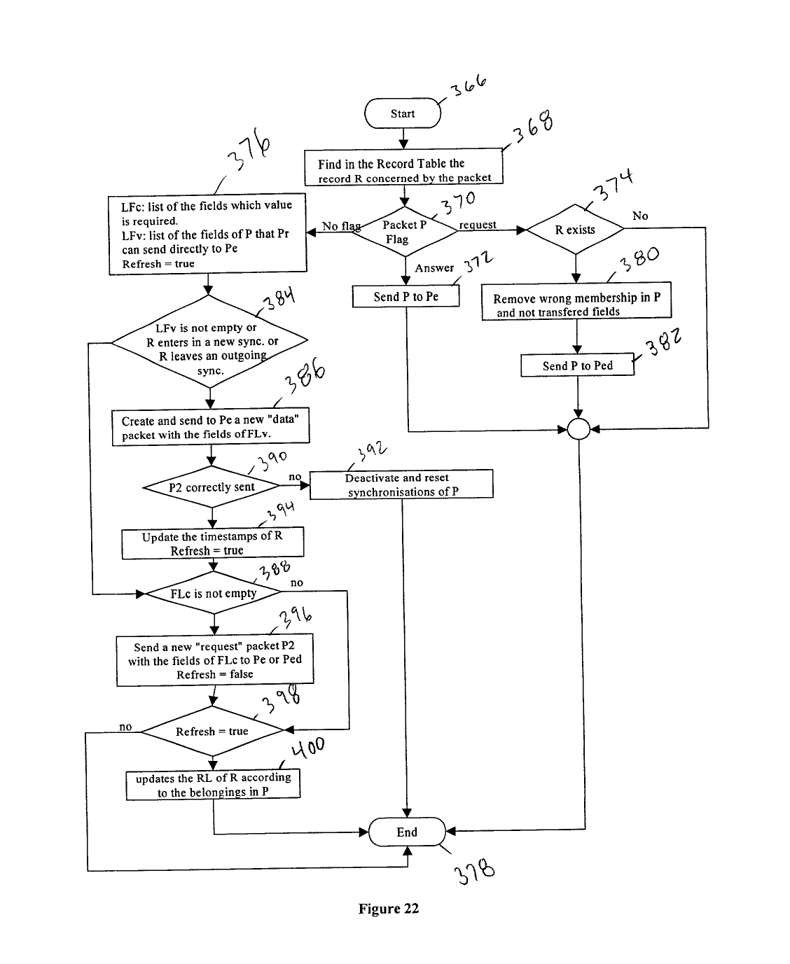

The process performed by Pr 136 is shown in FIG. 22. In this example, P is an incoming packet and R is the record in the record table of the SDB 132 associated with the packet. Step 366, the Pr 136 process is initiated by receipt of an incoming packet. Step 368, Pr 136 searches the record table in SDB 132 for the record R associated with the packet.

Step 370, Pr 136 determines flag in packet P. If the flag is “answer to a request,” proceed to step 372. If the flag is “request,” proceed to step 374. If there is no flag, proceed to step 376. Step 372, Pr 136 sends packet to Pe 152 and end process in step 378.

Step 374, Pr 136 determines if R exists in the record table of the SDB (REC-SDB)78. If no, processes is ended in step 378. If yes, proceed to step 380. Step 380, Pr 136 removes from P all wrong memberships (RL in the record table of the SDB 132 is the reference) and removes from P all fields that are not transferred by the synchronizations of P. Step 382, Pr 136 sends P to Ped 134 and ends process in step 378.

Step 376, Pr generates two list of fields ID by using information from R and P:

FLc: list of fields ID that value is required because they have no value in P and their timestamp in P is more recent than the timestamp of the corresponding fields in R.

FLv: list of the fields ID that will be put in the packet sent to Pe because they have a value in the timestamp of these fields in P is more recent than the timestamp of the corresponding field R.

Note:

FL v and FLc are exclusive (a field cannot belong to both lists).

If R doesn't exist in the table record, the timestamp of any fields in R is 0.

Particular case: if R doesn't exist in the table record and if there is no value in P for the fields that make part of the key in the local database then FLv is empty and FLc is the list of all the fields ID in P.

In step 384, determine if FLv is not empty or R enters in a new synchronization or R leaves an outgoing synchronization. If this condition is fulfilled process to step 386 otherwise process to step 388.Note : to determine if R is leaving or entering a synchronization, Pr 136 compares the belonging in the packet with the corresponding refresh level in R.

Example: for synchronization S1, if belonging is set at “1” in the packet and its RL is 0 in R, it means that R enter in S1.

Step 386, create a new “data” packet P2 with the fields of FLv and add membership “1” for all synchronization of P except for the synchronizations of SL-which are set to “−1”.

Note: membership “1” for an incoming synchronization means record deletion for the Plug-In 144. The sub-component that decides to remove a record from the DB 130 is the cleaner (N). This is the reason why, Pr 136 transform the incoming membership from “−1” to “1”.

Pr 136 sends P2 to Pe.

Step 390 determine if sending is Ok, if it is proceed to step 394. If not, proceed to step 392.

Step 392, Pr 136 deactivates and resets synchronizations of P and end process in step 378.

Step 394, Pr 136 updates the timestamp of the fields in R with the timestamp in P of the fields of FLv and set Refresh to true.

Step 388, Pr 136 determines if FLc is not empty. If not empty, proceed to step 398. If empty, proceed to step 396. Step 396, Pr 136 sets Refresh=false and creates a new “request” packet P2 with the fields of FLc and the all membership “1” of packet P. In step 396, depending on the source synchronizer of the synchronizations of P, Pr 136 will send P2 to Ped 134 or a remote Pe.

Step 398, If Refresh=true, Pr 136 updates the RL of R according to the synchronization membership in P and ends the process in step 378. Otherwise, the process is ended in step 378.

Pe

The main role of Pe 152 is to dispatch packets. If necessary, Pe 152 reads the synchronization membership in the packet or in SDB 132. Pe 152 forwards packets to the right destination table synchronizer(s) (or to the plug-in).

Pe 152 sends “out of synchronization” packet to a remote Pr (Pr') in order to inform him that a field does not belong anymore to a synchronization (for example, after a modification of the synchronization query).

Pe 152 receives from Pr data packets. Pe 152 receives from a remote Pr field packets with “request” flag or basic packet with “reset” flag

Pe 152 sends to a Remote Pr data packets. Pe 152 sends to Prd 142 data packets and Pe 152 sends to Pr 136 field data with “request” flag.

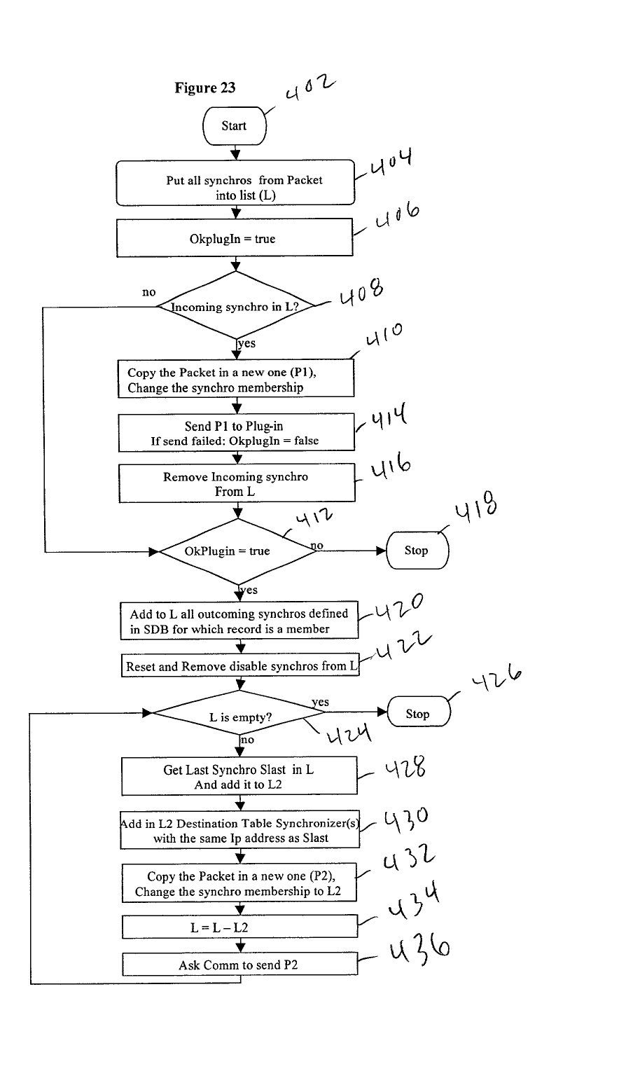

The Pe 152 process consists of the following steps (see FIG. 23):

A packet P arrives in step 402. If the packet has a “request” flag (it means that the packet is coming from remote Pr), then forward it to Pr 136. If a data packet has a “response” flag, Pe 152 removes the flag and sends this packet to the remote destination Table Synchronizer according to the synchronization membership of the packet.

If the format is a data packet containing information about a record R, Pe 152 puts all synchronizations mentioned in the membership of the packet into a list L, step 404. In step 404, Pe 152 selects in the SDB 132 the outgoing synchronizations for which the record R is a member and adds these synchronizations to L if they were not already present in it.

Step 406, Pe 152 sets the variable okPlugIn to true. Step 408, Pe 152 determines if there is at least one synchronization in L (incoming synchronization). If yes, proceed to step 410. If no, proceed to step 412.

Step 410, Pe 152 creates a new packet P1 and copies from P to P1 the field information associated with the synchronization in L. Step 414, Pe 152 sends P1 to plug-in 144. If the send operation failed, Pe 152 sets okplugln to false. Step 416, Pe 152 removes the incoming synchronization from L.

Step 412, Pe 152 determines if okPlugIn is true. If no, proceed to step 418 and stop the process. If yes, proceed to step 420.

Step 420, Pe 152 adds to L all outgoing synchronizations defined in SDB 132 for which R is a member. Step 422, Pe 152 removes and resets from L disabled synchronizations.

Step 424, Pe 152 determines if L is empty. If yes, proceed to step 426 and end the process. If L is not empty, proceed to step 428. Step 428, Pe 152 gets last synchro Slast in L and adds it to a new list L2. Step 430, Pe 152 adds in L2 all the synchronization of L which have the same Destination Table Synchronizer. Step 432, Pe 152 creates a new packet P2, copies from P to P2 the fields information associated with the synchronization in L, and inserts the synchronization membership (L2). Step 434, Pe 152 sets L=L −L2. Step 436, Pe 152 asks a communications module to send P2

Table Synchronizer Examples

The following section illustrates examples of how each Table Synchronizer subcomponents works during a synchronization process.

The notation “Qes(a)” means that the subcomponent Qes belongs to table Synchronizer a.

Creation of one record in a source database

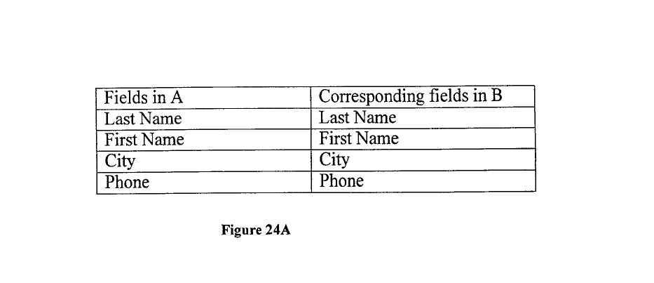

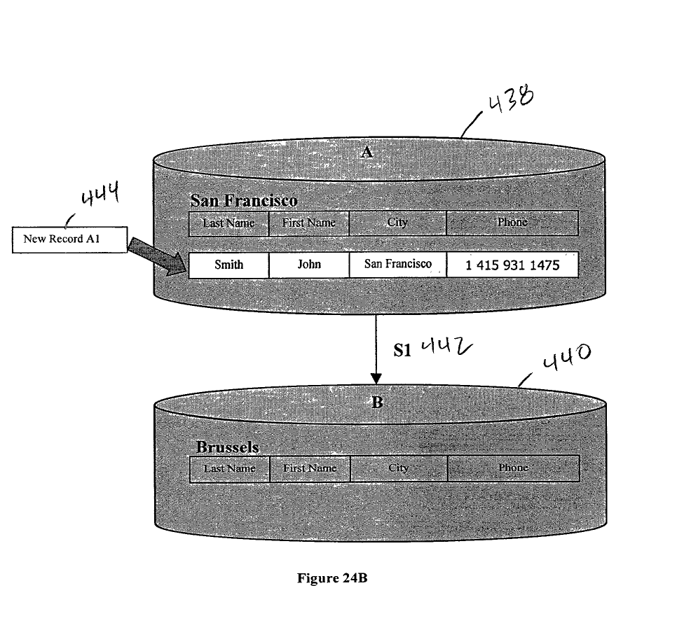

In this example, two empty databases 438(A) and 440(B) are synchronized with a synchronization 442(S1) defined as follows (see FIG. 24B):

Source database 438(A) and destination database 440(B)

Synchronization query SQ1: select [City]=San Francisco

Source synchronization field mask: [Last Name, First Name, City, Phone]

Source Record key for selection of records in 438: Key=[Last Name, First Name, City]

Destination synchronization field mask: [Last Name, First Name, City, Phone]

Record key for selection of records in 440: Key=[Last Name, First Name, City]

Field matching between A and B is shown in FIG. 24A. We assume that database 438(A) does not generate notifications so that the scanning detection method will be used.

Suppose that empty tables with the same structure already exist in 438 and 440, but that a new record 444(A1) is inserted in database 438 (see FIG. 24B).

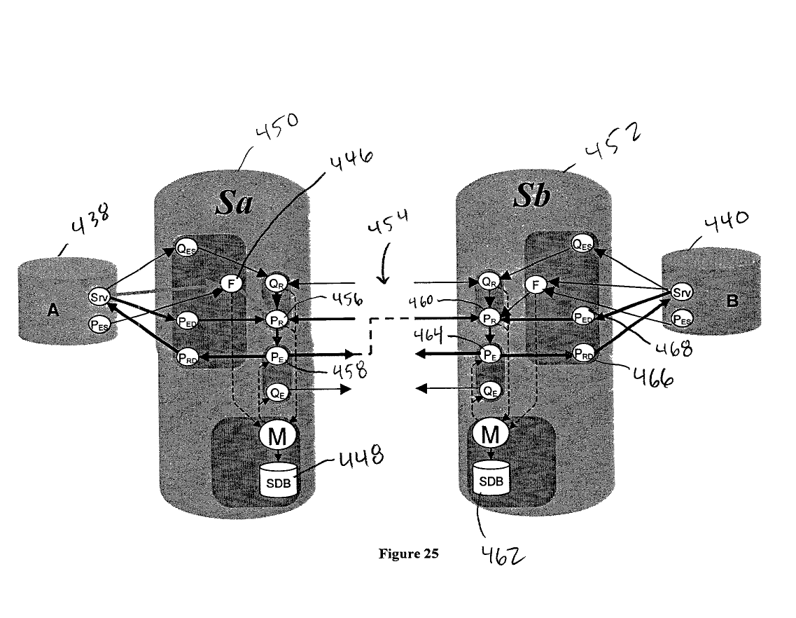

The synchronization steps are (see also FIG. 25):

The database 438 notifies F(a) 446 that a record 444(A1) has been added. F(a) 446 reads the field values in database 438.

F(a) 446 reads all the synchronization queries defined in SDB(a) 448 in order to find the synchronization(s) the record belongs to. In this case, F(a) 446 finds that the record 444(A1) belongs to synchronization 442(S1). Indeed, the record 444(A1) responds to the synchronization query {SQ1: select [city]=San Francisco}.

F(a) 446 creates the corresponding fields and inserts in the SDB(a) 448 a hashing function of the field values (A default value of timestamp is also inserted at the creation time. This value is the “OldestValue” timestamp” known by the synchronization system). In fact, the writing in the SDB(a) 448 does not occur immediately. The process waits for an acknowledgement (more precisely a return on function) confirming that the packet has been sent from Sa 450 to Sb 452 via the communication channel 454.

F(a) applies the source field mask, creates and sends a packet 1 to Pr(a) 456 with the 4 field values, the 4 timestamps (current time) and their associated synchronizations (S1 in this case).

Pr(a) compares for each field in packet 1 the timestamps in the packet with the timestamps of the SDB(a). Because Pr(a) detects a difference for all fields Pr(a) does not remove any information and forwards the packet 1 to Pe(a) 458.

Pe(a) reads the Synchronization definition of S1 in SDB(a). From this, Pe(a) knows the destination database and the communication channel to use. Pe(a) sends to Pr(b) 460 the packet 1.

Pr(b) receives packet 1. It compares the timestamp of fields in packet 1 with the corresponding timestamp in SDB(b) 462 and detects a creation of record. It creates the associated fields in SDB(b) and inserts the timestamps in SDB(b). In fact, the writing in SDB(b) does not occur immediately. The process waits for an acknowledgement (more precisely a return on function) confirming that the field value has been effectively written in the database 440.

Pr(b) sends packet 1 to Pe(b) 464.

Pe(b) detects that the synchronization is a incoming synchronization and sends the packet 1 to Prd(b) 466.

Prd(b) creates the record in database 440 and writes the value of the 4 fields contained in the packet 1 into the corresponding fields of database 440. Finally, Ped(b) 468 updates the hashing function of the 4 fields in SDB(b).

Field modification & Channel Disconnection

This example illustrates the synchronization process after a field modification in a source record. The modification occurs when the channel communication is down.

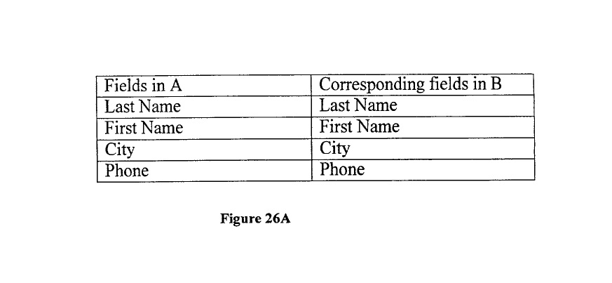

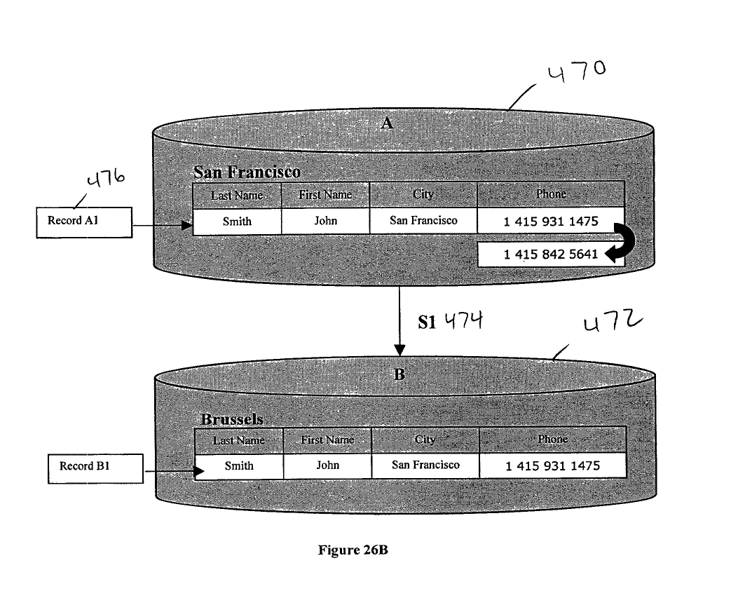

In this example, two databases A 470 and B 472 situated in San Francisco and Brussels respectively and containing one table (see FIG. 26B). The synchronization 474(S1) is defined by:

Source database 470(A) and destination database 472(B)

Synchronization query SQ1: select [city]=San Francisco

Source synchronization field mask: [Last Name, First Name, City, Phone] Source Record key for selection of records in A: Key=[Last Name, First Name, City]

Destination synchronization field mask: [Last Name, First Name, City, Phone]

Record key for selection of records in 472: Key=[Last Name, First Name, City]

Field matching between 470 and 472 is shown in FIG. 26A.

In this example, the database 470 is not able to generate notification. The detection method for changes in database 470 will be the scanning method.

A modification of the phone number in the record 476(A1) in the source database 470 takes place, the phone number changes from (1 415 931 1475) to (1 415 842 5641).

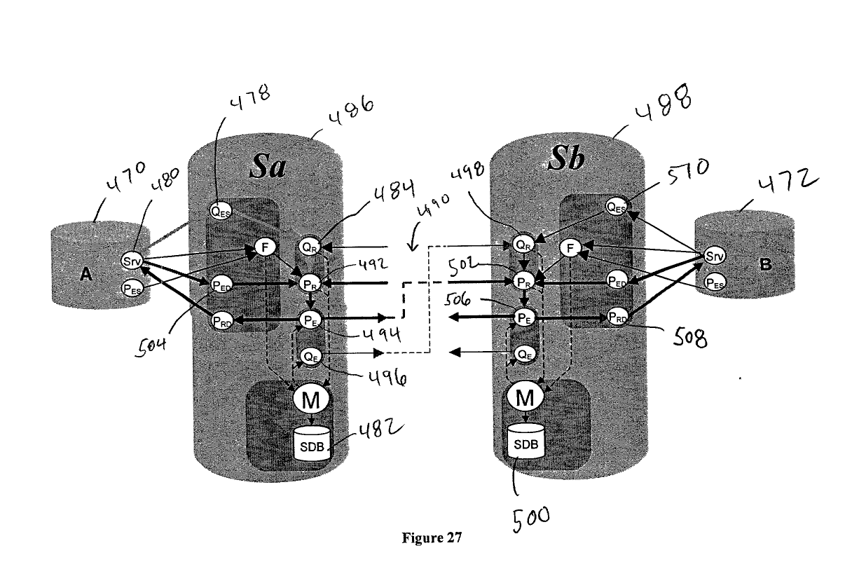

The synchronization steps are (see FIG. 27):

Qes(a) 478 launches the synchronization query SQ1 {select city=San Francisco} on database 470. Srv(a) 480 returns the record 476(A1). Qes(a) selects fields by applying the field mask [Last Name, First Name, City, Phone] corresponding to 474 (S1).

Qes(a) 478 calculates a hashing function on each field of the mask and compares the result with the hashing present in the SDB(a) 482. For the fields [Last Name, First Name, City], Qes 478 associates the timestamp 0 because it detects with the comparison of hashing values that no modification occurred. Otherwise, Qes 478 detects a modification for the field [Phone] and estimates the timestamp. Qes 478 based its estimation on the fact that the modification has occurred sometimes between the start of the previous Qes 478 loop and the current time.

Qes(a) sends a packet 1 with the timestamps and the field value to Qr(a) 484 and the associated synchronization S1.

Qes 478 updates the hashing in SDB(a). In fact, the writing in SDB(a) does not occur immediately. The process waits for an acknowledgement (more precisely a return on function) confirming that the packet has been sent from Sa 486 to Sb 488 via the communication channel 490.

Qr(a) just forwards the packet 1 to Pr(a) 492.

Pr(a) compares for each fields in packet 1 the timestamps in the packet with the timestamps of the SDB 482. Pr(a) detects a difference for the field [Phone] and updates this timestamp in SDB 482. In fact, the writing in SDB(a) does not occur immediately. The process waits for an acknowledgement (more precisely a return on function) confirming that the packet has been sent from Sa to Sb via the communication channel.

Pr 492 filters this packet 1 removing from the packet information relative to non-modified fields [Last Name, First Name, City]. Only information relative to the field[Phone] remains in packet 1.

Pe(a) 494 cannot send the packet 1 to Sb since the communication channel is interrupted.

Suppose that the communication channel between 470 and 472 is restored.

Qe(a) 496 detects that the communication channel is up. Qe(a) scans SDB(a) synchronization by synchronization. It first sends a packet to Qr(b) 498 to advertise that the following packets concern S1 and then processes each records of S1. Because S1 concerns one record (A1), Qe(a) sends only one packet 2 to Qr(b) containing a hashing function calculated on all timestamps in SDB(a) of fields in the field mask of S1. Qe(a) sends a packet to inform Qr(b) that the processing on S1 is finished.

Qr(b) receives the packet 2 from Qe(a) and calculates the same hashing function but this time on field timestamps in SDB(b) 500. It compares this hashing with the hashing in packet 2 and deduces that a modification occurred for one of the field of the field mask of S1. Qr(b) sends a request packet 3 to Qe(a) to ask timestamps of each field of the field mask.

Qe(a) answers with packet 4 with timestamps for the for fields of record A1 in SDB(a).

Qr(b) forwards the packet 4 to Pr(b) 502.

Pr(b) receives the packet 4 and compares the timestamps in the packet with timestamps in SDB(b). Timestamps are different only for the field [Phone]. Pr(b) sends a request packet 5 to Pe(a) in order to get the value for the field[Phone].

The packet 5 passes through Pe(a), Pr(a) and arrives to Ped(a) 504, which extracts the value of Field[Phone] in record A1 of database 470.

Ped(a) updates the hashing value for field [Phone] in SDB(a), generates and sends a packet 6 to Pr(a) containing the timestamp and field value.

Pr(a) forwards the packet 7 to Pe(a) with the timestamp, field value, and synchronization S1.

Pe(a) reads the Synchronization definition of S1 in SDB(a). From this, Pe(a) knows the destination database and the communication channel to use. Pe(a) forwards packet 7 to Pr(b). Note here that Pe(a) does not check the synchronization membership because the packet is an answer to a request.

Pr(b) receives packet 7. It compares the timestamp of field [Phone] in packet 7 with the value in SDB(b) and detects a modification for the field. It updates the value of timestamp in the SDB(b). In fact, the writing in SDB(b) does not occur immediately. The process waits for an acknowledgement (more precisely a return on function) confirming that the field value has been effectively written in database 472.

Pr(b) forwards packet 7 to Pe(b) 506.

Pe(b) forwards packet 7 to Prd(b) 508.

Prd(b) reads in the SDB(b) the record key corresponding to the synchronization S1. With this key, Prd(b) selects the record in database 472 and writes the value of the field [Phone] contained in packet 7 into the Field [phone] of database 472. Finally, Prd(b) updates the hashing value of the Field[Phone] in SDB(b).

Change of query, suppression in destination source, user flag

This example illustrates the synchronization process following a synchronization query modification causing, according to the user flag, the suppression (or not) of the destination record.

In this example, two databases 470(A) and 472(B) are located in San Francisco and Brussels respectively. Each database contains one table.

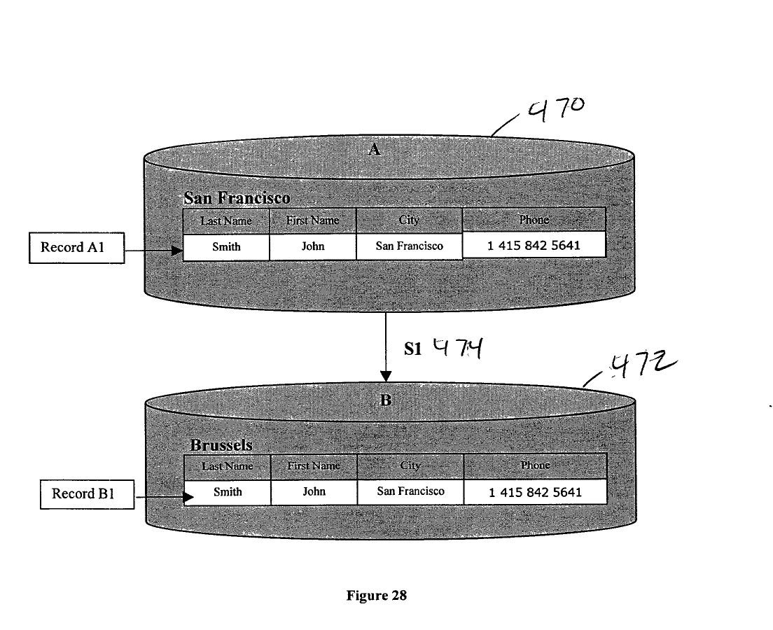

Assume an initial situation described in FIG. 28 and assume too that the synchronization definition S1 474 is changed:

From:

Source database 470(A) and destination database 472(B)

Synchronization query SQ1: select city=San Francisco

Source synchronization field mask: [Last Name, First Name, City, Phone]

Source Record key for selection of records in 470: Key=[Last Name, First Name, City]

Destination synchronization field mask: [Last Name, First Name, City, Phone]

Record key for selection of records in 472: Key=[Last Name, First Name, City]

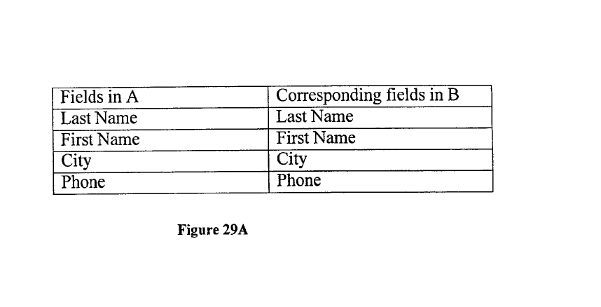

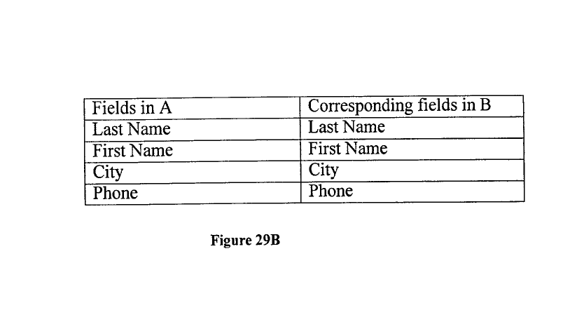

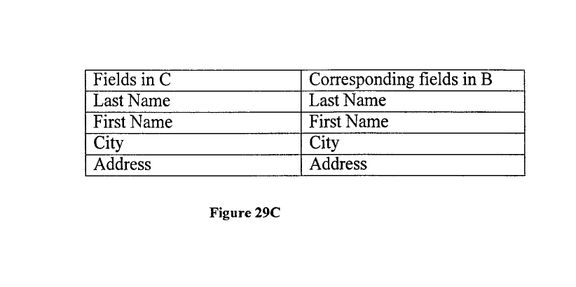

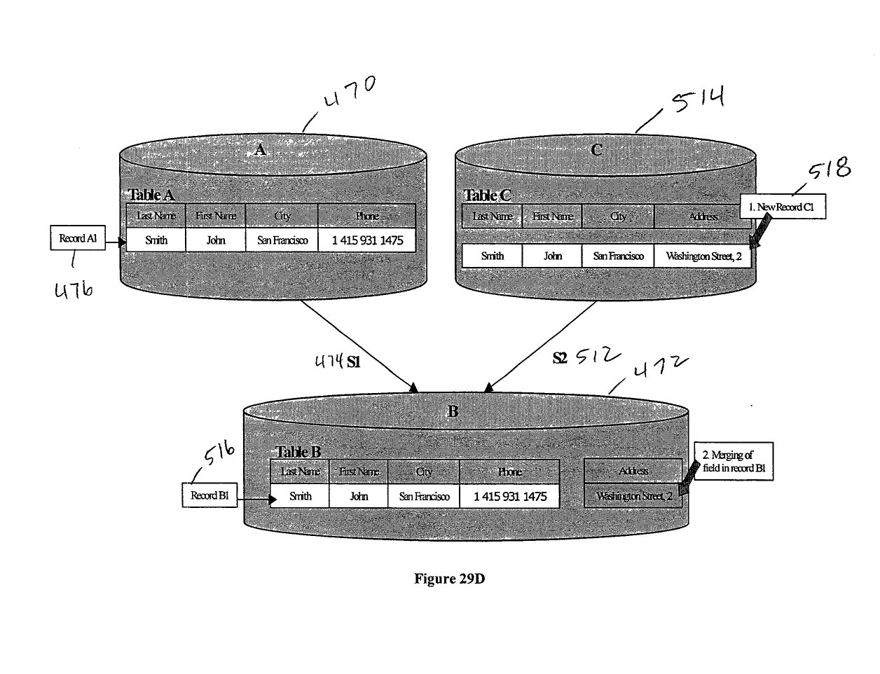

Field matching between 470 and 472 for this example is shown in FIG. 29A.

To: the same definition except for the synchronization query:

Synchronization query SQ1: select [city]=Boston

Also, suppose here that no notification mechanism is available.

The synchronization process is as follows:

When Qes(a) starts and ends treatment of a query, it sends to Qr(a) a start and end packet respectively. During the loop, Qes(a) does not select any record in the database A with the synchronization query SQ1 (select [city]=Boston) on database 470.

Qr(a) receives the end packet and starts a cleaning process for all synchronized fields for which it has not received information from Qes(a). In this case, a cleaning process is started for the fields in record A1.

The cleaning process removes from the SDB 482 all fields of record A1 and asks Pe(a) to send a special packet “out of synchronization” to all synchronizations the record A1 belongs to. In this case a “out of synchronization” packet is sent from Pe(a) to Pr(b) indicating that the record A1 is out of S1.

Two cases must be considered here:

No field has been locally changed in database 472

Pr(b) receives the packet “out of synchronization” from Pe(a). Pr(b) removes the membership to S1 of all fields in record A1 in SDB(b).

Because S1 is the last (only) synchronization associated to the fields, Pr(b) sends a “delete” packet to Pe(b).

The “delete” packet passes through Pe(b) and arrives to Prd(b). Prd(b) checks in SDB the user flag and deletes the records in database 472 because the user flag is “off”.

A field has been locally changed:

Suppose that the Field [Phone] in database 472 has been changed by a local access (from 1 415 842 5641 to 1 415 842 5965) after the change of synchronization query, but before the “out of synchronization” packet arrives to Sb.

The local modification has initiated the following actions in Sb:

A local modification in Field[Phone] in database 472 is detected by Qes(b) 510. Qes(b) updates the user flag in SDB 500 sends a packet containing timestamps for Field[Phone]

Pr(b) updates the timestamp in SDB 500.

The “out of synchronization” packet arrives after the local modification.

Pr(b) receives the packet “out of synchronization” from Pe(a). Pr(b) removes the membership to S1 of all fields in record A1 in SDB(b).

The user flag set to “on” prevents Pr(b) from sending a delete packet to Prd(b).

Merging:

This example illustrates the merging of fields coming from 2 records in 2 databases into one destination record. Let's define 2 synchronizations S1 474 and S2 512:

The synchronization S1 is defined by:

Source database 470(A) and destination database 472(B)

Synchronization query SQ1: select [city]=San Francisco

Source synchronization field mask: [Last Name, First Name, City, Phone]

Source Record key for selection of records in 470: Key=[Last Name, First Name, City]

Destination synchronization field mask: [Last Name, First Name, City, Phone]

Record key for selection of records in 472: Key=[Last Name, First Name, City]

Field matching between A and B for this example is shown in FIG. 29B:

The synchronization S2 is defined by:

From:

Source database (C) 514 and destination database (B) 472

Synchronization query SQ2: select [city]=San Francisco

Source synchronization field mask: [Last Name, First Name, City, Address]

Source Record key for selection of records in 470: Key=[Last Name, First Name, City]

Destination synchronization field mask: [Last Name, First Name, City, Address]

Record key for selection of records in 472: Key=[Last Name, First Name, City]

Field matching between C and B for this example is shown in FIG. 29C.

The detection method is the notification method for all the databases.

Initially, records 476(A1) and 516(B1) exist in database A and B respectively (see FIG. 29D).

Suppose that a new record 518(C1) is created in C.

The synchronization steps are:

The database C notifies F(c) that a record (C1) has been added. F(c) reads the field values in database C.

F(c) reads all the synchronization queries defined in SDB(c) in order to detect the synchronization(s) the record is belonging to. In this case, F(c) detects that the record C1 is belonging to synchronization S2. Indeed, the record C1 responds to the synchronization query {SQ2: select [city]=San Francisco}.

F(c) creates the corresponding fields and inserts in the SDB(c) a hashing function of the field values (a default value of timestamp is also inserted at the creation time. This value is the “oldest timestamp” known by the synchronization system).

For the record C1, F(c) also inserts in SDB(c) a local identifier (IDlocal C1) and a global identifier (IDglobal C1). In a synchronizer there is one unique IDlocal per record. For a record, its IDlocal is unique within a synchronizer while its IDglobal is unique within a network of synchronization.

F(c) applies the field mask and sends to Pr(c) a packet 1 with the 4 field values, the 4 timestamps (current time) and their associated synchronizations.

Pr(c) compares for each field in packet 1 the timestamps in the packet with the timestamps of the SDB. Pr(c) detects a difference for all fields. Pr(c) forwards the packet 1 to Pe(c).

Pe(c) reads the Synchronization definition of S1 in SDB(c). From this, Pe(c) knows the destination database and the communication channel to use. Pe(c) sends to Pr(b) the packet 1.

When the packet is coming, the synchronizer tries to convert the record IDglobal into an IDlocal via the information coming from the SDB(b). This conversion fails because the record does not exits yet. The IDlocal is temporary set to 0.

Pr(b) receives packet 1. It compares the timestamp of fields in packet 1 with the value in SDB(b) and detects a creation of fields. Pr(b) forwards the packet to Pe(b). and is waiting for a confirmation that fields have been modified in database B before updating the timestamp(s) in SDB(b).

Pe(b) forwards the packet to Prd(b)

Prd(b) builds a record C1′ from the packet 1. From the key record definition of SQ2 in SDB(b) and the value of the key in record C1′, Prd(b) reads the record C1 in database B. Prd(b) compares the records C1 and C1′ and detects that the field [Address] is not present in C1′.

Prd(b) inserts the value of the Field [Address] in C1. It checks if a record with the key value is present in SDB and sees that it is the case. Prd(b) adds in SDB(b) the IDglobal C1 beside the already existing IDglobal Al. Prd(b) also adds the hashing function of the field[address].

The key point here is the fact that only one record is maintained in database B and SDB(b).

Pr(b), which was waiting, updates the timestamp for Field[Address] in SDB(b).

It is understood that the functional aspects of the invention can be implemented in hardwired circuitry, by programming a general purpose processor, or by any combination of hardware and software. For example, each of the functional aspects of the invention, such as Qr or Pd, may correspond to a sequence of instructions stored in a memory.

Although certain presently preferred embodiments and examples of the present invention have been specifically described herein, it will be apparent to those skilled in the art to which the invention pertains that variations and modifications of the various embodiments and examples shown and described herein may be made without departing from the spirit and scope of the invention.

What is claimed is:

1. A data processing method for synchronizing data records of a source database and a destination database, the method comprising:
defining a synchronization set for data records existing in the source database;
synchronizing the source database and the destination database based on the synchronization set; and
changing the definition of the synchronization set while synchronizing the source database and the destination database.

2. The data processing method of claim 1, further comprising:
removing a data record from the destination database based on the step of changing the definition of the synchronization set.

3. The data processing method of claim 1, further comprising:
deleting a data record belonging to the synchronization set from the source database; and
removing the data record from the destination database based on the deleting of the data record in the source database.

4. A data processing method for synchronizing data records of a plurality of databases, the method comprising:
defining a synchronization set for data records existing in at least one of the plurality of databases;
synchronizing the plurality of databases based on the synchronization set; and
changing the definition of the synchronization set while synchronizing the plurality of databases.

5. The data processing method of claim 4, further comprising:
removing a data record from at least one of the plurality of databased on the step of changing the definition of the synchronization set.

6. The data processing method of claim 4, wherein the step of synchronizing the plurality of database includes merging data from at least two of the plurality of databases into a data record in one of the plurality of databases.

7. A data processing method for synchronizing data records of a source database and a destination database, the method comprising:
defining a synchronization for data records existing in the source database;
synchronizing the source database and the destination database based on the synchronization set; and
scanning the data records in the source database defined in the synchronization set.

8. The data processing method of claim 7, further comprising:
receiving a plurality of queries for information on data records defined in the synchronization set; and
Wherein the step of scanning includes combining the plurality of received queries before scanning the source database.

9. The data processing method for synchronizing data records of a source database and a destination database, the method comprising:
defining synchronizing set for data records existing in the source database;
synchronizing the source database and the destination database based on the synchronization set; and
creating a notification packet for each data record defined in the synchronization set and modified in the source database, the notification packet containing only an indication of modification.

10. A data processing method for synchronizing data records of a source database and a destination database, the method comprising:
defining a synchronization set for data records existing in the source database;
synchronizing the source database and the destination database based on the synchronization set; and
creating a user flag each data record defined in the synchronization set and modified in the destination database.

11. A data processing method for synchronizing data records of a source database and a destination database, the method comprising:
defining a synchronization set for data records existing in the source database;
hashing information on the data records defined by the synchronization set; sending the hashing information to the destination database; and
synchronizing the source database and the destination database based on the synchronization set.

12. The data processing method of claim 11, further comprising:
receiving a request for hashing information on at least on data record defined by the synchronization set at the source database from the destination database; and
sending the at least one data record to the destination database.

13. A data processing method for synchronizing data records of a plurality of databases, the method comprising:
defining synchronization links for a unidirectional synchronized data transfer between any two of the plurality of databases;
defining a combination of the synchronization links, for synchronizing a plurality of databases;
synchronizing the databases; and
applying the database record changes to all the linked databases.

14. The data processing method of claim 13, further comprising:
defining a query to identify a subset of the data records to synchronize from a source database for each link.

15. The data processing method of claim 13, further comprising:
defining a subset of data records fields to synchronize from a source database for each link.

16. The data processing method of claim 13, further comprising:
defining a matching between a source database field and destination database field for each link.

17. The data processing method of claim 13, further comprising:
defining a merging of a transferred data records in a destination database for each link.

18. The data processing method of claim 13, further comprising:
defining a merging of data fields in destination database records for each link.

19. The data processing method of claim 13, further comprising:
defining a field transformation function for each transferred data field.

20. The data processing method of claim 13, further comprising:
encrypting synchronized data fields at a source database and decrypting the data fields at a destination database.

21. The data processing method of claim 13, further comprising:
keeping synchronization information for each data record of a synchronized database; comparing the synchronization information between linked databases for each link; and
sending the data records from a source database to a destination database, based on the comparison for each link.

22. The data processing method of claim 21, further comprising:
restarting the step of comparing when a synchronization link is broken and reestablished.

23. The data processing method of claim 21, further comprising:
keeping a unique global ID for each synchronized data record.

24. The data processing method of claim 21, further comprising:
keeping a hashed value for each data field in the synchronized records;
keeping a modification time for each data field in the synchronized records; and
updating the modification time when the hashed value is changed.

25. The data processing method of claim 21, further comprising:
updating the synchronization information by scanning the plurality of databases.

26. The data processing method of claim 25, further comprising:
combining a query of multiple synchronization links into one query for scanning.

27. The data processing method of claim 21, further comprising: updating the synchronization information when receiving database change notifications.

28. The data processing method of claim 27, further comprising: activating the step of updating based on the status of synchronization information, while synchronizing.

29. The data processing method of claim 21, further comprising: keeping a user flag for each field in the synchronized records.

30. The data processing method of claim 13, further comprising:
adding, removing or changing a synchronization link definition while synchronizing the plurality of databases.

31. The data processing method of claim 30, further comprising:
adding records or fields into records in a destination database when a synchronization link is added or changed.

32. The data processing method of claim 30, further comprising:
removing records or fields from a destination database when a synchronization link is removed or changed.

33. The data processing method of claim 32, further comprising: protecting a field from removal based on a status of a user flag.

34. The data processing method of claim 13, further comprising:
protecting the plurality of database coherence by transferring all modified fields of a logical record together.

35. The data processing method of claim 13, further comprising:
accessing shared synchronized databases while other processes or applications are modifying the synchronized databases.

36. The data processing method of claim 13, further comprising:
keeping meta-data information for each synchronized database.

37. The data processing method of claim 13, further comprising:
merging all synchronization information for a synchronized database into an information database, the information being synchronization links information, record synchronization information, and meta-data information.

38. The data processing method of claim 37, further comprising:
synchronizing information database of linked synchronized databases; and creating synchronization links between the information databases.

39. The data processing method of claim 13, further comprising:
creating a destination database for each synchronization link; and
changing a destination database structure for each synchronization link.

40. A computer system configured to synchronize data records of a source database and a destination database, the system comprising:
a processor; and
a memory coupled to said processor; the memory having stored therein sequences of instructions which, when executed by said processor, cause said processor to synchronize data records of the source database and the destination database by causing the processor to perform the steps of:
defining a synchronization set for data records existing in the source database;
synchronizing the source database and the destination database based on the synchronization set; and
changing the definition of the synchronization set while synchronizing the source database and the destination database.

41. An article of manufacture that includes a medium readable by a processor, the medium having stored thereon a plurality of sequences of instructions, said plurality of sequences of instructions including sequences of instructions which, when executed by a processor, cause said processor to perform the steps of:
defining a synchronization set for data records existing in a source database;
synchronizing the source database and a destination database based on the synchronization set; and changing the definition of the synchronization set while synchronizing the source database and the destination database.
